(19) United States
(12) Patent Application Publication
(10) Pub. No.: US 2017/0126592 A1
(43) Pub. Date: May 4, 2017

(54) Method Implemented in an Online Social Media Platform for Sharing Ephemeral Post in Real-time

(71) Applicant: Samy El Ghoul, Boca Raton, FL (US)

(72) Inventor: Samy El Ghoul, Boca Raton, FL (US)

(21) Appl. No.: 14/925,016

(22) Filed: Oct. 28, 2015

(51) Int. Cl. H04L 12/58; G06F 17/24; H04L 29/08; G06F 17/30

(52) U.S. Cl. CPC H04L 51/04; G06F 17/3071; G06F 17/24; H04L 51/24; H04L 51/32; H04L 51/10; H04L 67/306

(57) ABSTRACT

Disclosed is an implementation of a method for an online social media platform to extract the user's location as the user uploads and shares an ephemeral post in real-time based on the privilege setting configured by the user. Further, the method determines a plurality of locations around the vicinity of the registered user's location when an ephemeral post is uploaded/shared by the registered user, and the method pictographically represents the uploading and sharing activity performed by the user through the online social media platform within the network.

### BACKGROUND

The present invention relates to implementing a method for uploading and sharing an ephemeral post in real-time within a network and more particularly about implementing a method for extracting the user's location and tracking an ephemeral post related activity that is performed in real-time through an online social media platform based on the privilege setting configured by a registered user within a network.

The existing social media applications allow the user to perform various activities online and share the content with other users through the network online or offline, wherein the applications allow the user to track the activities both in real-time as well as in non-real-time (synchronously/asynchronously). However, the social media applications are not capable of instantly uploading and sharing an ephemeral post with a plurality of social networking system entity (ies) within the network based on the privilege setting. In today's scenario, there is a need to share the ephemeral posting instantly within the network based on the network access privilege configured by the user with different access privileges, and to extract the user's location as the ephemeral posting related activity is tracked within the network.

Hence, there is a need to implement a method for an online social media platform to extract the user's location and track the ephemeral post related activity performed in real-time based on the privilege setting configured by the registered user.

### SUMMARY

The present invention is related to a method implemented for extracting the location of a registered user and tracking an ephemeral post related activity in real-time through an online social media platform based on the privilege setting configured by a registered user within a network, wherein the method identifies a plurality of locations around the vicinity of the registered user's location when an ephemeral posting is captured and shared in real-time within the network by the registered user. Further, the method allows the registered user to capture the ephemeral post in one or more modes through the online social media platform and allows the registered user to initiate an ephemeral chat session through the online social media platform. Further, the method allows the registered user to edit the ephemeral post before sharing the ephemeral post through the online social media platform and depicts a plurality of locations as a public story based on the frequency of capturing and posting the ephemeral posting in real-time through the online social media platform. Further, the method categorizes the ephemeral posting based on one or more factors including the extracted location of the registered user while performing the ephemeral post related activity in real-time through the online social media platform. Further, the method receives notification information about the ephemeral post related activity performed by the user(s) following the registered user through the online social media platform.

Other objects and advantages of the embodiments herein will become readily apparent from the following detailed description taken in conjunction with the accompanying drawings.

### BRIEF DESCRIPTION OF THE DRAWING(S)

FIG. 1, according to an embodiment of the present invention, is an overview of a system 100 implementing the method to perform an ephemeral post related activity through an online social media platform 104 in real-time within a network 101.

FIG. 2, according to an embodiment of the present invention, illustrates a flow-chart 200 that explains the process of instantly uploading and sharing an ephemeral post within the network 101.

FIG. 3, according to an embodiment of the present invention, illustrates a system overview of components 300 used to implement the method.

FIGS. 4a and 4b, according to an embodiment of the present invention, depicts a loading screen and a login screen for allowing the user to register with an online social media platform 104 and to login to the platform 104 through a mobile interface.

FIGS. 5a and 5b, according to an embodiment of the present invention, depicts a login screen and a registering screen for allowing the user(s) to instantly share and upload the ephemeral post with the linked third-party social networking sites through the online social media platform 104.

FIG. 6, according to an embodiment of the present invention, depicts a screen-shot for providing link accounts to connect/integrate the online social media platform 104 with the third-party social networking sites.

FIGS. 7a and 7b, according to an embodiment of the present invention, depict screen-shots for the user to find the list of friends and/or invite friends through the online social media platform 104 who are registered/unregistered with the online social media platform 104 and/or connected to the third party social networking sites.

FIGS. 8a and 8b, according to an embodiment of the present invention, depict screen-shots to capture the ephemeral post in different modes through the online social media platform 104.

FIGS. 9a, 9b, 9c, 9d, and 9e, according to an embodiment of the present invention, depict screen-shots for displaying the user's profile and managing the user's profile through the online social media platform 104.

FIGS. 10a and 10b, according to an embodiment of the present invention, depict screen-shots to manage the follower's user profile and the list of users following the user's profile through the online social media platform 104.

FIGS. 11a, 11b, 11c, 11d, 11e, and 11f, according to an embodiment of the present invention, depict a pictographical representation of ephemeral posting related activity to navigate through the map to view the ephemeral post related activity through the online social media platform 104 and to select active postings captured around the world that are identified with the hash tag names.

FIGS. 12a, 12b, and 12c, according to an embodiment of the present invention, depicts a Nearby page that displays the most liked uploads at the nearby locations and the most recent uploads recognized within the nearby locations as determined by the online social media platform 104 based on the user's location while capturing/uploading the ephemeral post.

FIGS. 13a, 13b, 13c, 13d, and 13e, according to an embodiment of the present invention, depict screen-shots used to edit the ephemeral post through the mobile interface.

FIG. 14, according to an embodiment of the present invention, depict screen-shots used to instantly upload and share the ephemeral post with one or more social networking system entities 105 within the network 101.

FIGS. 15a, 15b, 15c, 15d, 15e, and 15f, according to an embodiment of the present invention, depict screen-shots used to initiate an online ephemeral individual chatting session and/or an ephemeral group chatting session and to view the ephemeral chatting session text, video, image exchanged in real-time.

FIGS. 16a and 16b, depict screen-shots used to upload the ephemeral post through the online social media platform 104 and to view the ephemeral postings shared through the group chatting session initiated through the online social media platform 104.

FIGS. 17a, 17b, and 17c, according to an embodiment of the present invention, depict screen-shots used to view the notification information received from the following user(s) and the ephemeral post related activity performed by the current user through the online social media platform 104.

FIGS. 18a, 18b, 18c, 18d, and 18e, according to an embodiment of the present invention, depict screen-shots used to configure the privilege settings for uploading and sharing the ephemeral post through the online social media platform 104.

FIGS. 19a, 19b, and 19c, according to an embodiment of the present invention, depict screen-shots used to configure the privacy settings for the ephemeral post, uploads liked by the registered user, and clearing conversation in the chat room through the online social media platform 104.

### FIGURES

### Reference Numerals

100—A system implementing a method for an online social media platform
101—A network within which the method is implemented
102—A user registered with an online social media platform that is configured to implement a method for enhancing the real-time uploading and sharing activity within the network.
103—Implementation of a real-time ephemeral posting method
104—An online social media platform implemented with a real-time ephemeral posting method.
105—Represents social networking system entity (ies) connected within the network
200—A flow-chart explaining the process of a real-time ephemeral posting method
300—A System overview of components used for implementing the real-time ephemeral posting method
301—An Application module
302—A Registration module
303—A Location identifier module
304—An Integration module
305—A Configuration module
306—A Controlling module
800—An image capturing page
801—An icon to switch between front mode and back mode while capturing the image
802—A user's profile
803—An icon to represent a chat room session
804—An icon for sharing the notification information
805—An icon for capturing an image/video in the selected mode
806—An icon for playing the public story captured across the world
807—An icon for playing the public story around the vicinity of the user performing an ephemeral post related activity.
901—An icon for receiving notification information
902—An icon for blocking the user from following the user's profile
903—An icon for listing/reporting a list of user(s) following the user's profile
1101—A pictographical representation of the ephemeral posting depicting a high rate of uploading/sharing ephemeral posting activity
1102—A pictographical representation of the ephemeral posting depicting an active uploading/sharing ephemeral posting activity
1103—A pictographical representation of the ephemeral posting depicting a low rate of uploading/sharing activity

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

In an embodiment, an online social media platform 104 is supported with a mobile interface which can be installed on a mobile device, and the mobile device can refer to a Smart phone, a Tablet, a Laptop, a Personal Computer, hand-held Personal digital assistants (PDAs), or the like, which can upload and share an ephemeral posting in real-time through the online social media platform 104.

In an embodiment, an ephemeral post refers to an image or a video captured through an online social media platform 104 and/or a user's profile that can be instantly shared with one or more social networking system entity (ies) 105 within the network 101. The method 103 allows the ephemeral post to be saved/stored in the online social media platform 104 for a short span of time of 24 hours(when shared with the public users) or until other user(s) (private user(s) or list of following user(s)) within the network 101 view the ephemeral posting through the online social media platform 104. Further, as the ephemeral post is viewed by the private user(s) or the following user(s) through the online social media platform 104, the method 103 removes/deletes the ephemeral post from the online social media platform 104.

In an embodiment, the social networking system entity (ies) 105 refer to an online networking community interacting through the social media platform 104 installed on a mobile device, a social networking site registered with the social media platform 104, a following list of users, a private group of contacts, a public network, a followers list, a group chat list, or the like with which the method 103 allows the user to perform the ephemeral posting related activity in real-time.

The terms registered user and user are used interchangeably throughout the document and the terms third-party social networking web sites, third-party social media web site, third-party social media application(s) are used interchangeably.

In an embodiment, the term ephemeral post related activity refers to capturing, uploading, sharing, and/or editing the ephemeral post through the online social media platform 104.

In an embodiment, the term current user refers to the owner of the user's profile (the registered user 102) initiating an ephemeral posting related activity through the online social media platform 104 and other user refers to a user other than the registered user 102/owner of the user's profile. Further, the term private user(s) refers to other user(s) who are following the current user's profile.

In an embodiment, the term public story refers to the accumulation of a plurality of ephemeral posts that are posted by a plurality of users based on the registered user's location and the term world story refers to accumulation of a plurality of ephemeral posts that are posted by a plurality of users across the world.

In an embodiment, the term private story refers to the ephemeral post uploaded/shared by a registered user with a private list of users or with the list of users following the registered user and the term My story refers to the ephemeral post uploaded/shared by the registered user with the private list of users or with the list of users following the registered user.

In an embodiment, the online social media platform 104 is configured with a mobile interface to manage and handle the ephemeral post (public story/private story) or a real-time ephemeral group or individual chat session.

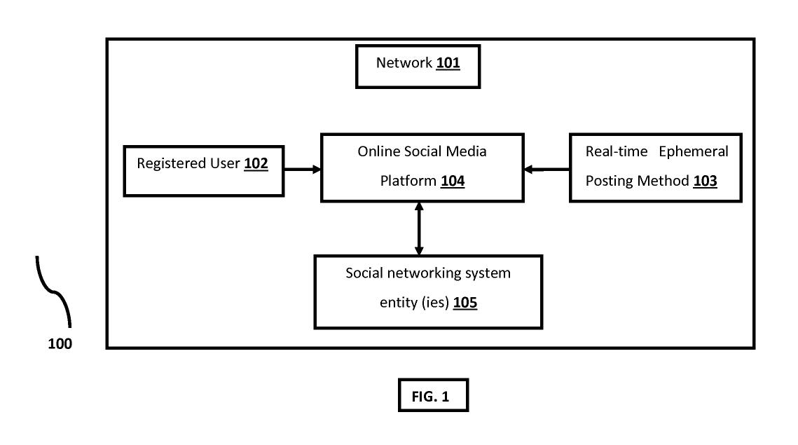

Referring to FIG. 1, depicts an overview of a system 100 implementing the method to perform the ephemeral post related activity through an online social media platform 104 in real-time within a network 101. In an embodiment, as the registered user 102 captures an ephemeral post through the online social media platform 104, the method 103 allows the user 102 to instantly upload and share the captured ephemeral post with one or more social networking system entity (ies) 105 within the network 101. In an embodiment, the social networking system entity (ies) 105 must be linked with the online social media platform 104 for uploading and sharing the captured ephemeral post in real-time. For example, the online social media platform 104 needs to be linked with the social networking site such as Face book®, Instagram®, Google®, Twitter®, and so on to share and upload the ephemeral posting, captured through the platform 104, on the social networking site.

In an embodiment, the platform 104 can share the captured ephemeral post with the social networking system entity (ies) 105 based on the privilege settings configured by the user, wherein the privilege settings allow the user to share the captured ephemeral post with the entire world (as public posting) or with a private group of people who are following the user's profile (depicted as My Story tab in the mobile interface of the platform 104). In an embodiment, the mobile interface of the online social media platform 104 allows the user to configure the privilege setting for different types of social networking entity (ies) associated with the user, wherein the types of social networking entity (ies) configured with the privilege setting associated with the user includes a following list of users, a public network linked through a social media account, a private network or the personalized network facilitated by the My Story tab provided in the mobile interface of the platform 104, or through a group setting. Further, the mobile interface of the platform 104 allows the user to instantly share and upload the ephemeral post based on the privilege setting configured for the social networking entity (ies).

In an embodiment, the online social media platform 104 extracts the location of the user 102 performing an ephemeral post related activity through the online social media platform 104, wherein the extracted location can refer to the location of the mobile device of the user 102, the location of the user 102 performing the ephemeral post related activity.

In an embodiment, the mobile interface of the platform 104 depicts a plurality of locations pictographically based on the frequency of capturing and posting the ephemeral posting in real-time through the social media platform 104. In an embodiment, the platform 104 facilitates categorization of the ephemeral post based on various factors associated with the ephemeral posting posted in real-time through the online social media platform 104.

In an embodiment, the online social media platform 104 facilitates an instant ephemeral group/individual chatting session for the social networking system entity (ies) 105 and facilitates identification of a plurality of locations around the vicinity of the user who captures and uploads the ephemeral post through the online social media platform 104.

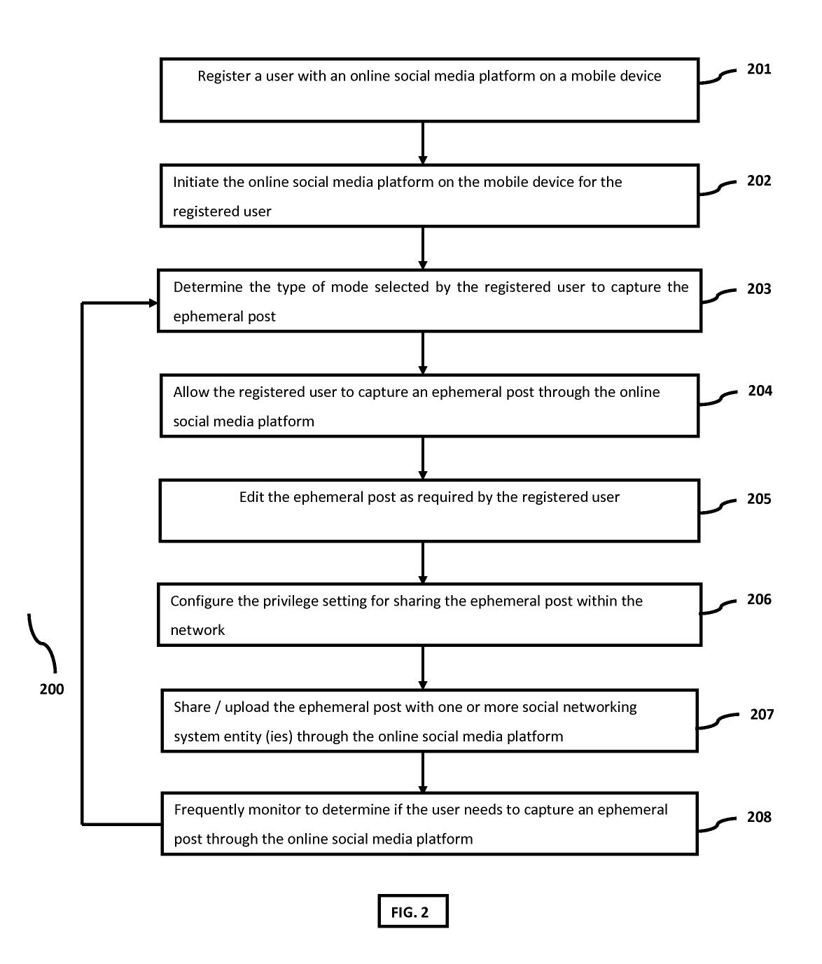

Referring to FIG. 2, depicts a flow-chart 200 that explains the process of instantly uploading and sharing an ephemeral post within the network 101. Initially, at step 201, the method 200 allows a user to register with the online social media platform 104 through the mobile interface that is installed on the mobile device. At step 202, the method 200 allows the registered user 102 to initiate the platform 104 on the mobile device. As the platform 104 is initiated on the mobile device, at step 203, the method 200 allows the user to determine the type of mode required to capture the ephemeral posting through the platform 104, wherein the type of mode that can be selected by the current user 102 includes but not limited to an image capturing in frontback mode, a video capturing mode, a time lapse mode, a slow motion mode. At step 204, the method 200 allows the current user 102 to capture the ephemeral post through the platform 104 based on the type of capturing mode selected in the previous step. Further, at step 205, the method 200 allows the current user 102 to edit the ephemeral post as required through the mobile interface of the platform 104, wherein editing the ephemeral post comprises of adding tag names to the ephemeral post, adding timer to the ephemeral post, drawing over the ephemeral post, sharing the ephemeral post with the social networking system entity (ies) 105, storing or removing the ephemeral post from the platform 104, or the like. At step 206, the method 200 allows the user to configure the privilege setting for instantly uploading and sharing the captured ephemeral post with the social networking system entity (ies) 105. Further, at step 207, the method 200 uploads and shares the ephemeral post with the social networking system entity (ies) through the platform 104. Further, at step 208, the method 200 frequently monitors to determine if the current user 102 needs to capture an ephemeral post through the platform 104 for sharing and uploading the captured ephemeral post in real-time within the network 101.

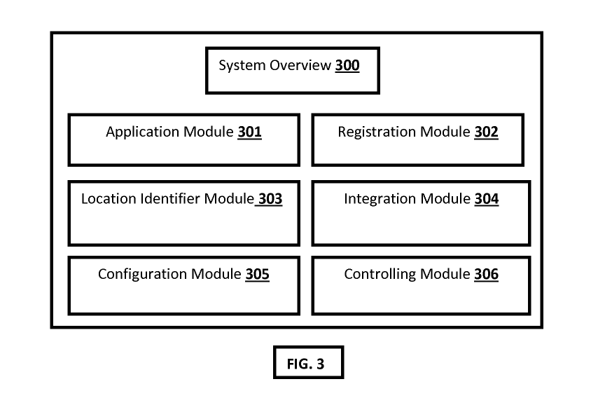

Referring to FIG. 3, illustrates a system overview of components 300 used to implement the method. In an embodiment, the enhanced social media application 103 comprises of the following components: An Application module 301, a Registration module 302, a Location Identifier module 303, an Integration module 304, a Configuration module 305, and a Controlling module 306. The Application module 301 is configured to support the online social media platform 104 on the mobile device. The Registration module 302 is configured to register one or more users with the online social media platform 104. The Location identifier module 303 is configured to instantly recognize the activity performed by the user to determine the plurality of locations around the vicinity of the user capturing and uploading the ephemeral post within the network 101. The Integration module 304 is configured to integrate one or more social networking system entity (ies) 105 with the online social media platform 104. The Configuration module 305 allows the registered user 102 to configure the platform 104 with privilege settings for uploading and sharing the ephemeral post in real-time through the online social media platform 104. The Controlling module 306 is configured to control the data transfer across various modules supported by the system 100 implementing the method 103.

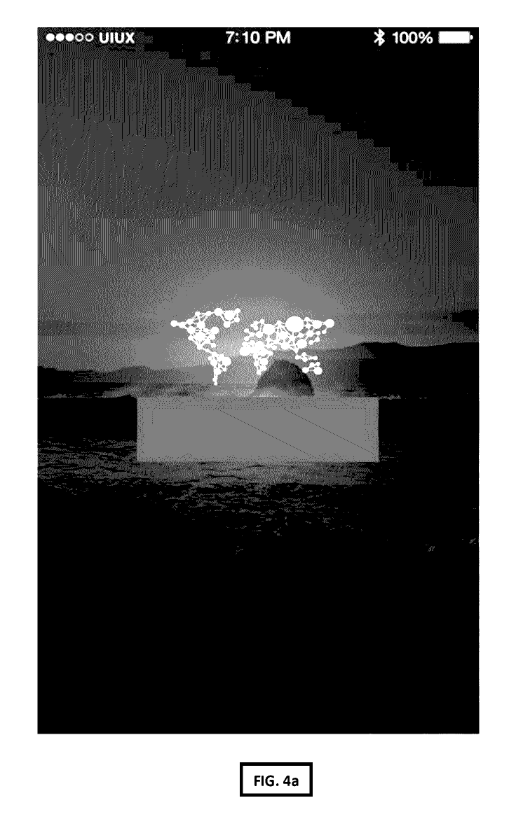

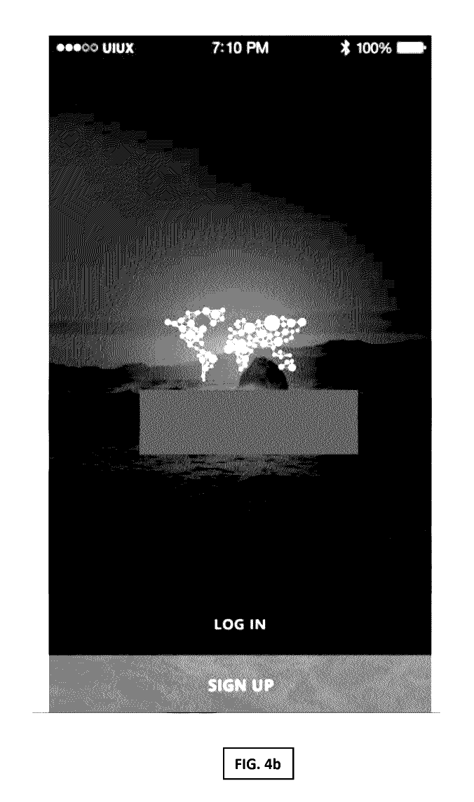

Referring to FIGS. 4a and 4b, depicts a loading screen and a login screen for allowing the user to register with the online social media platform 104 and to login to the platform 104 through the mobile interface.

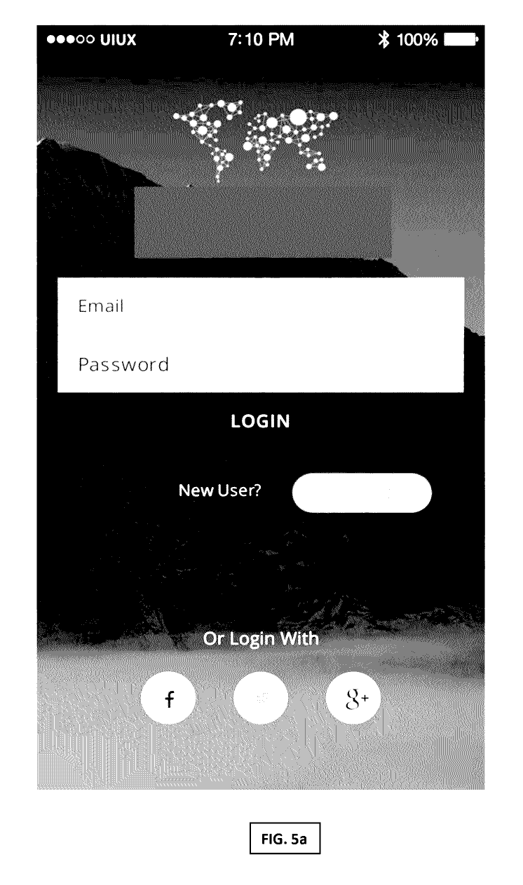

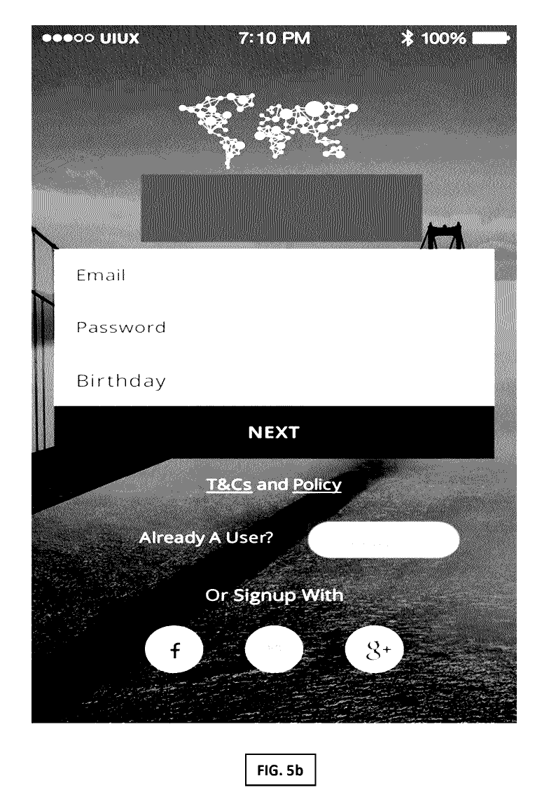

Referring to FIGS. 5a and 5b, depicts a login screen and a registering screen for allowing the user(s) to instantly share and upload the ephemeral post with the linked third-party social networking sites within the network 101 through the online social media platform 104. In an embodiment, the online social media platform 104 allows the user 102 to register with the third-party social networking sites by accepting the user account associated with the social networking sites such as Face book®, Google®, Twitter®, or the like for instantly uploading and sharing the ephemeral post captured through the online social media platform 104. Further, as the ephemeral post is uploaded on the social networking site, the ephemeral post available on the social networking site such as Face book®, Google®, Twitter®, or the like is controlled and managed by the associated third-party social networking site.

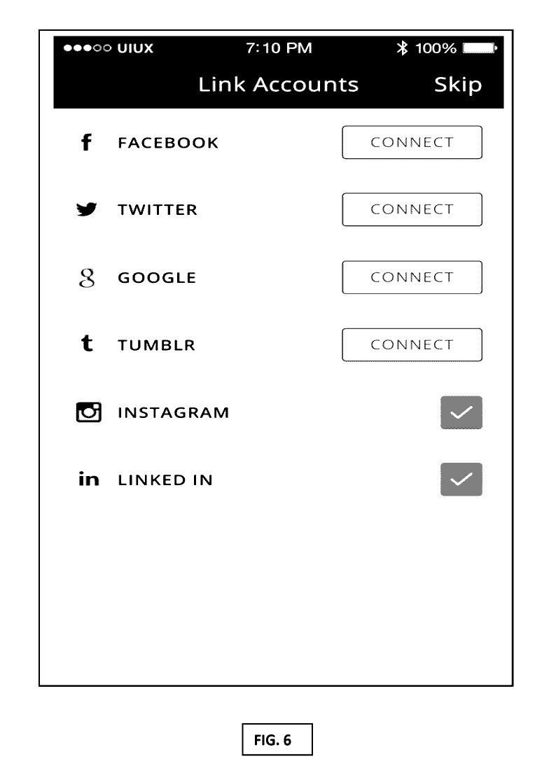

Referring to FIG. 6, depicts a screen-shot for providing link accounts to connect/integrate the social media platform 104. In an embodiment, the online social media platform 104 allows the registered user 102 to link the platform 104 with one or more third-party social media applications such as Face book®, Twitter®, Google®, Tumblr®, or the like. Further, as the platform 104 is integrated with the third-party social media application, a network of users registered with the integrated third-party social media application can be invited and/or registered with the online social media platform 104. In an embodiment, the online social media platform 104 is configured to connect to the third-party social media application(s) installed on the mobile device and allows the user 102 to send request to synchronize and link with the connected applications by accepting the user account (username and password) associated with the third-party social media application(s).

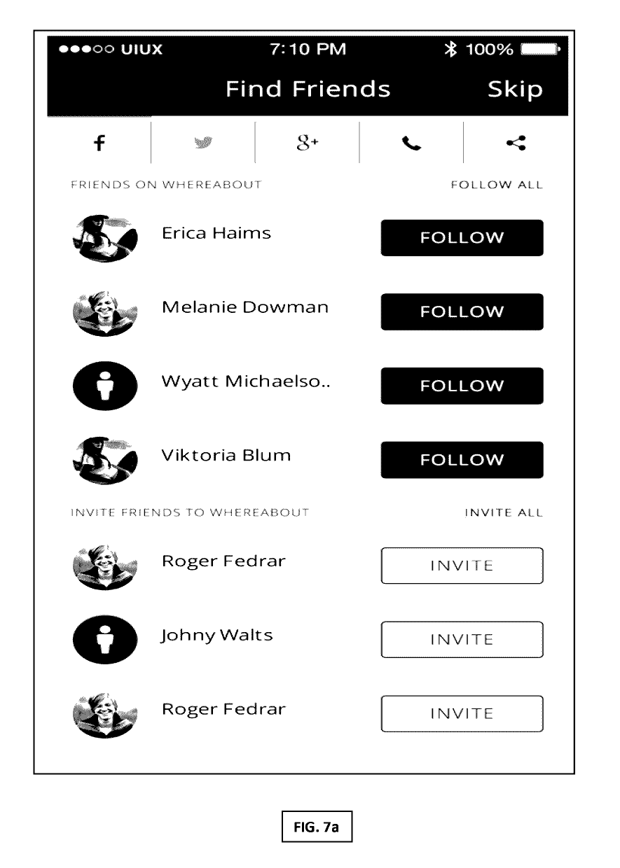

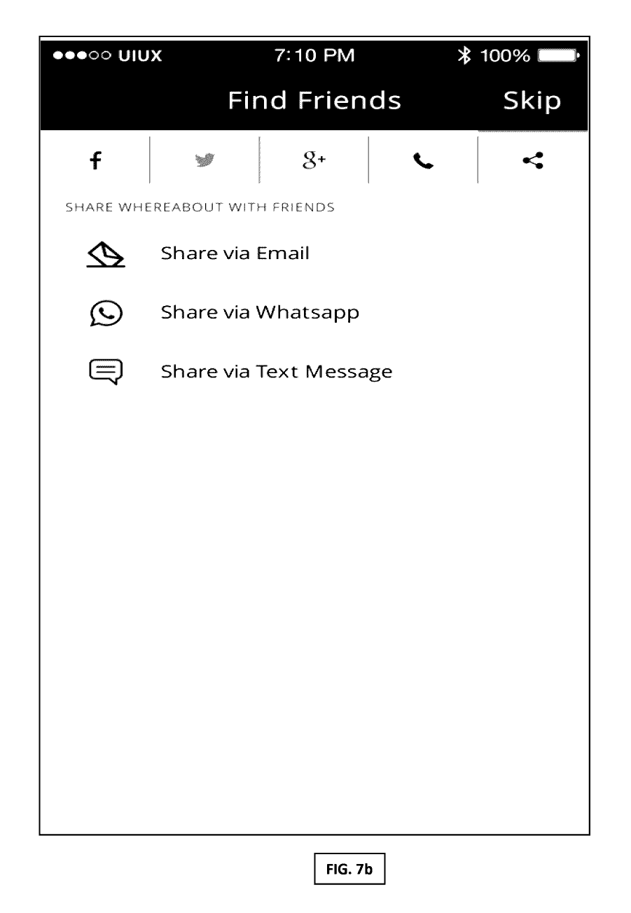

Referring to FIGS. 7a and 7b, depict screen-shots for the user to find the list of friends and/or invite friends through the online social media platform 104 who are registered/unregistered with the online social media platform 104 and/or connected to the third party social media web sites. As the online social media platform 104 is integrated with one or more third-party social networking sites, the list of friends/known contacts available/listed in the third-party social media websites can be searched and invited for registering with the online social media platform 104. In an embodiment, the online social medial platform 104 can invite the friends/known contacts, listed in the third-party social media web sites, through various means such as an email, an SMS, a text message, or the like. Further, the online social media platform 104 allows the user 102 to invite the friends/known contacts through the linked third-party social media application(s) that is registered with the online social media platform 104.

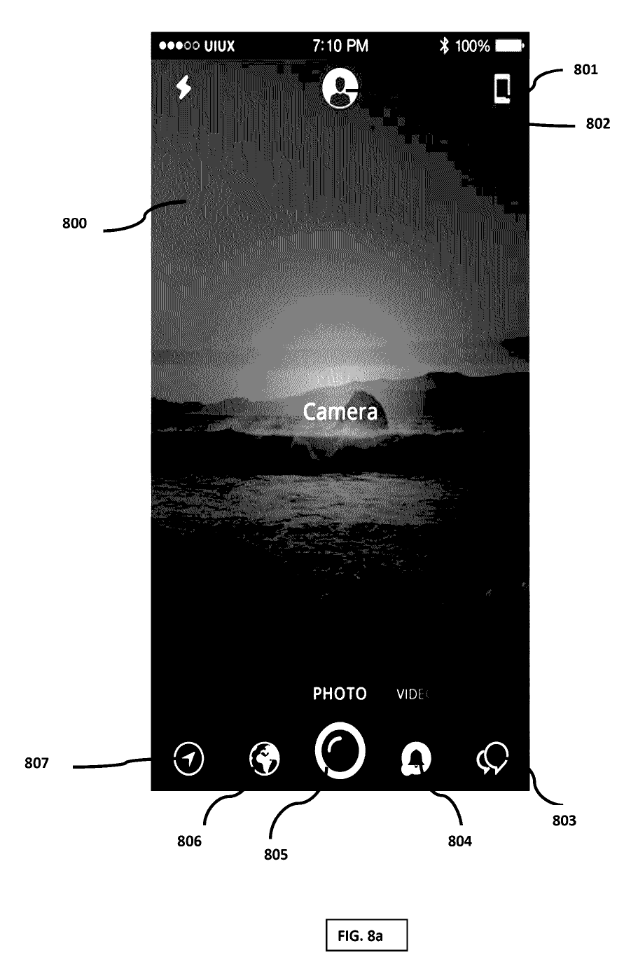

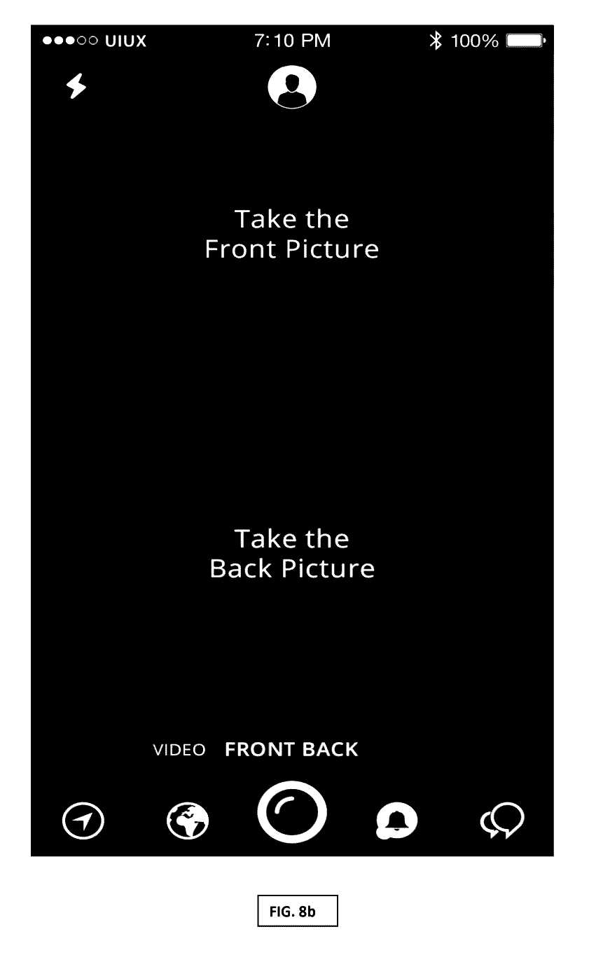

Referring to FIGS. 8a and 8b, depict screen-shots to capture the ephemeral post in different modes through the online social media platform 104. In an embodiment, the online social media platform 104 allows the user to capture the images in a FRONTBACK mode, a Photo or Video capturing mode, a Time lapse mode, or a Slow motion mode. The photo icon 805 as depicted in the screen shot 800 is used for capturing the images in different modes. Further, the image captured through the FRONTBACK mode can display the front image at the top 40% portion of the screen and the back image can be displayed in the bottom 60% portion of the screen. In an embodiment, the Camera capturing page 800 illustrates the following icons: an icon 801 to switch between a front mode and a back mode and vice versa for capturing an image, an icon 802 to display the user profile, an icon 803 to initiate an online chat session, an icon 804 to display the notification message, an icon 805 to capture images in the frontback mode, an icon 806 to capture the ephemeral posting activity occurring across the world, an icon 807 to determine the nearby locations around the vicinity of the user 102 performing an ephemeral post related activity.

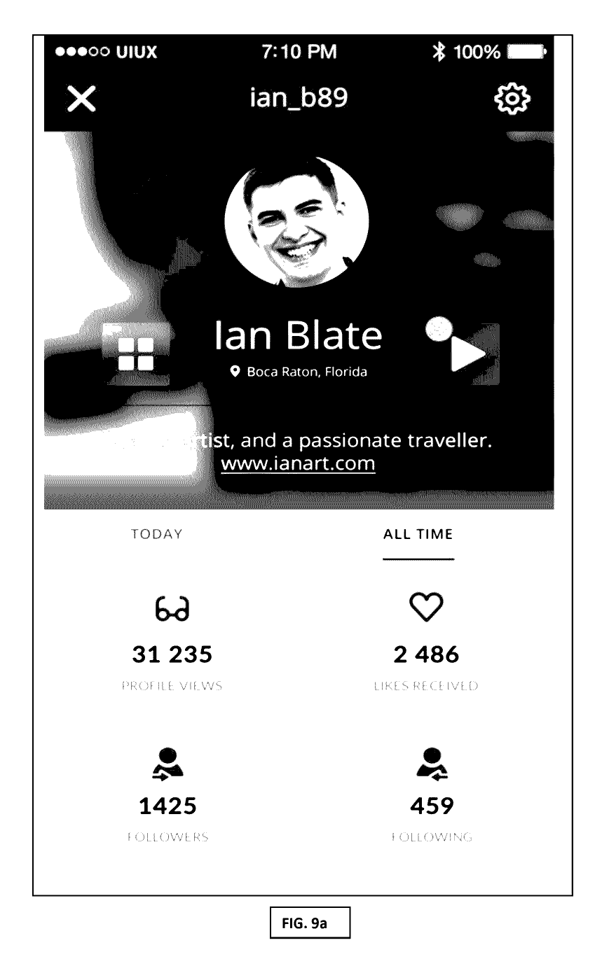

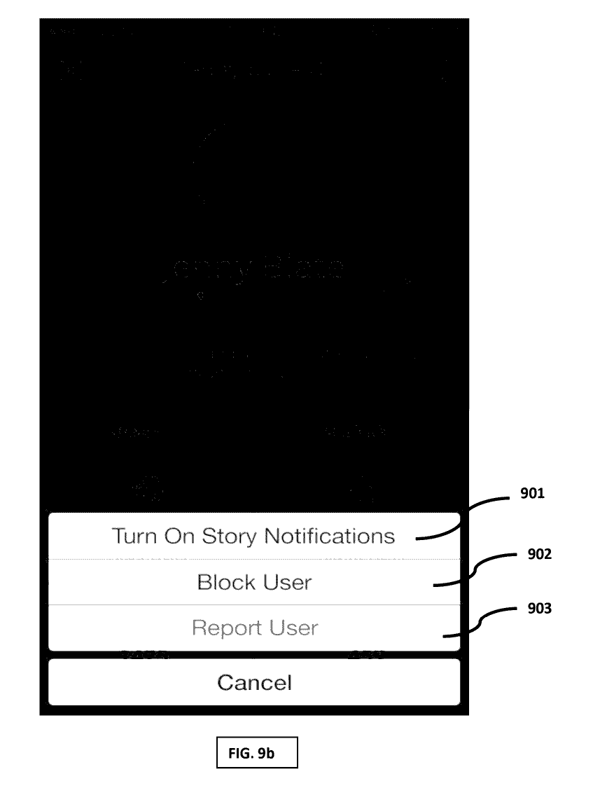

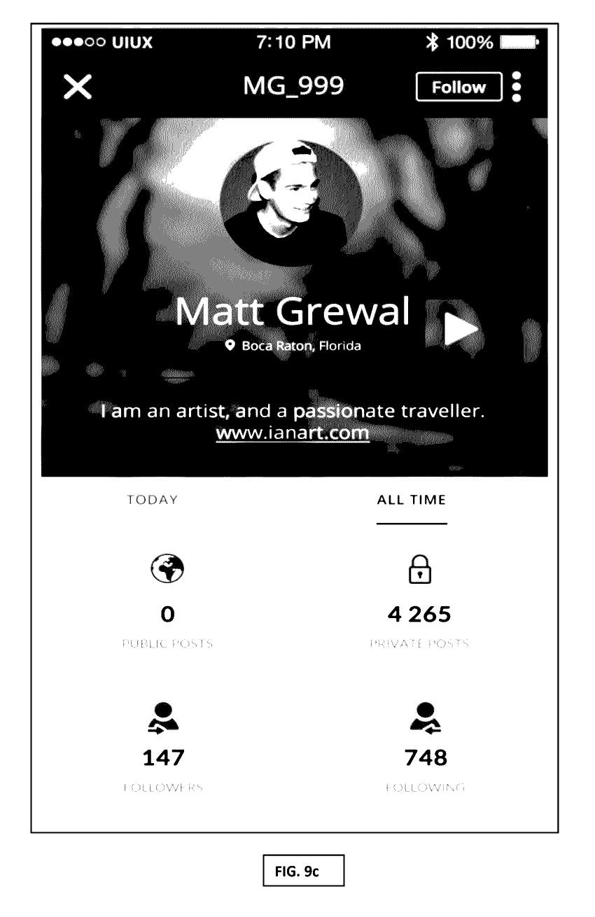

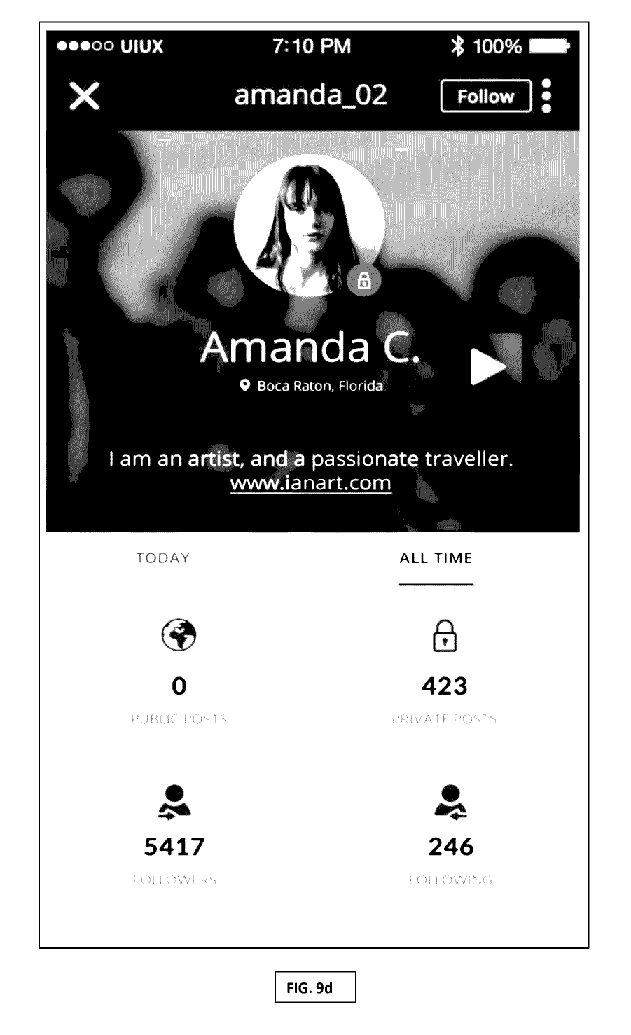

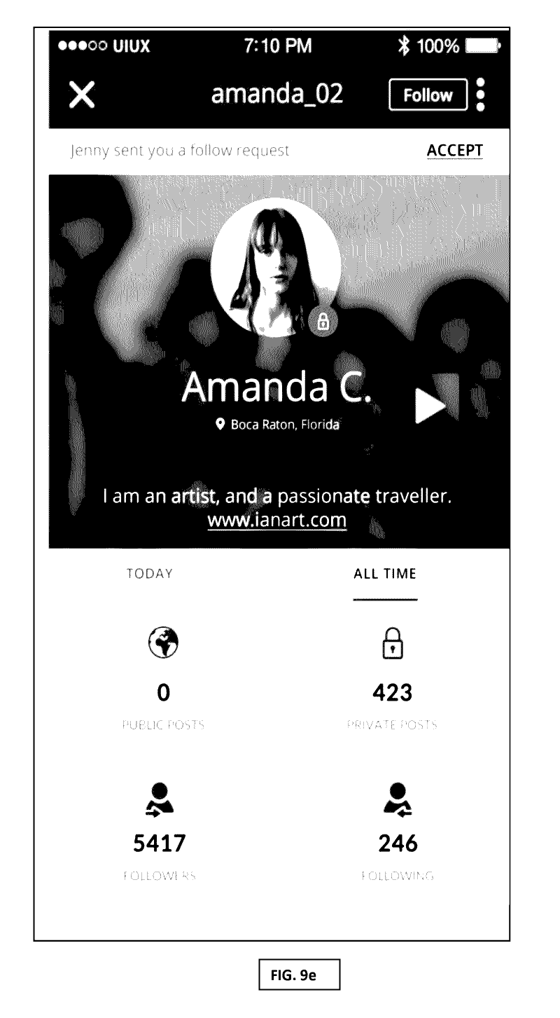

Referring to FIGS. 9a, 9b, 9c, 9d, and 9e, depict screen-shots for displaying the user's profile and managing the user's profile through the online social media platform 104. In an embodiment, the online social media platform 104 is configured to manage the user's profile and information such as the number of followers following the user's profile, number of views captured for the user's profile, number of likes received for the user's profile, profile update history such as the number of followers following the user's profile, the number of user profile(s) the user is following, or the like. Further, the information captured for the user's profile can be associated with a time period such as the information can be captured for the current day (depicted by the TODAY tab on the mobile interface) or the information can be captured continuously (depicted by the ALL TIME tab on the mobile interface). Further, the information captured for the user's profile is also referred to as information statistics, which includes but not limited to the profile views, likes received, and the number of followers following the user's profile. FIG. 9a, depicts the user profile that can be managed by the user 102. FIG. 9b, depicts the following user and further the screen shot provides an option 901 to select the users to follow the current user's profile for receiving the notification about the ephemeral posting related activity. FIG. 9c, depicts a public user's profile that is not following the current user's profile. FIG. 9d, depicts a private user's profile that is not following the current user's profile. FIG. 9e, depicts a private user's profile that is requesting to follow the current user's profile.

In an embodiment, the mobile interface of the online social media platform 104 allows the user to configure the user's profile privilege settings, wherein the privilege settings allows the user's profile to be viewed by the public or by a selected number of users as opted/configured by the user through the profile settings.

In an embodiment, the mobile interface of the online social media platform 104 allows the user to manage the user's profile, wherein managing the user's profile comprises of selecting the user(s) 901 to turn on/off the notification information, blocking selected user(s) from accessing the user's profile 902 within the network 101, and reporting users who have opted to access the user's profile 903.

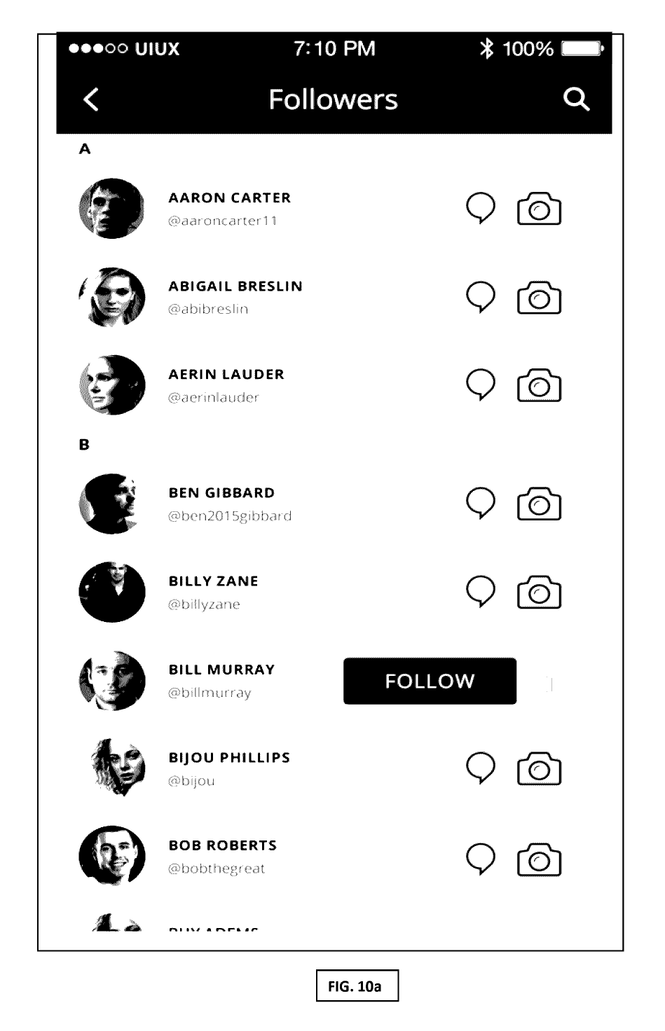

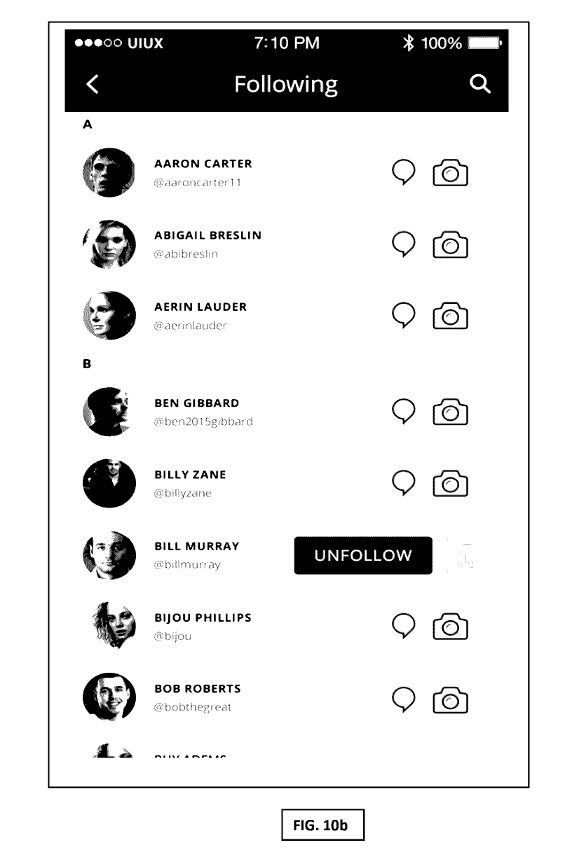

Referring to FIGS. 10a and 10b, depict screen-shots to manage the follower's user profile and the list of users following the user's profile through the online social media platform 104. In an embodiment, the mobile interface of the online social media platform 104 allows the user to select the list of user profiles the current user is following and the list of users following the current user's profile page. In an embodiment, the mobile interface of the platform 104 allows the user to select one or more followers to follow the user's profile page and/or allows the user to unfollow one or more followers following the user's profile page.

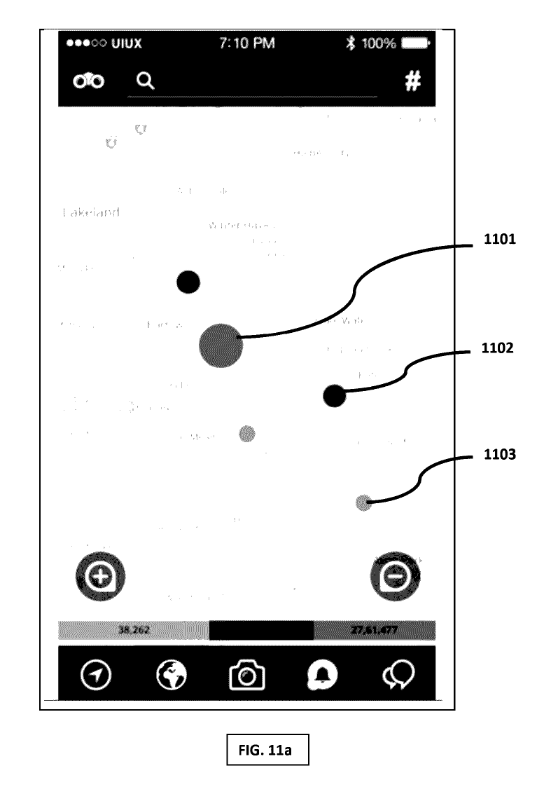

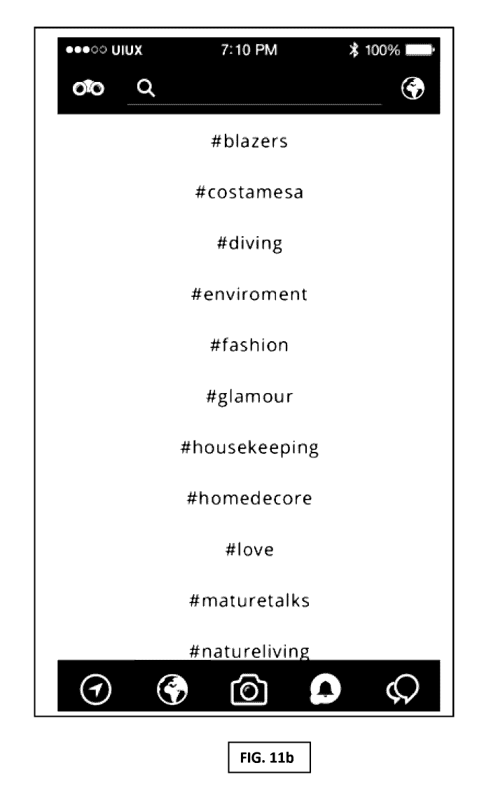

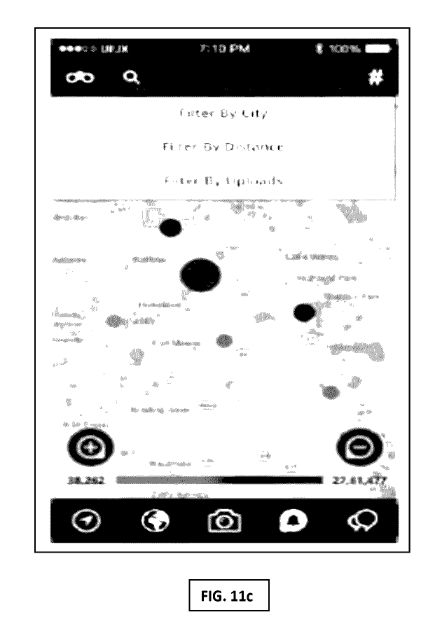

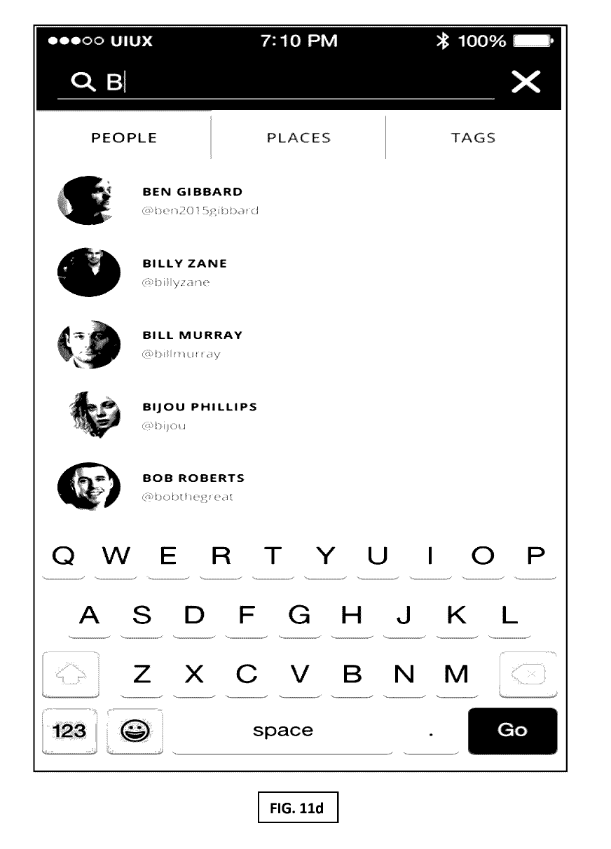

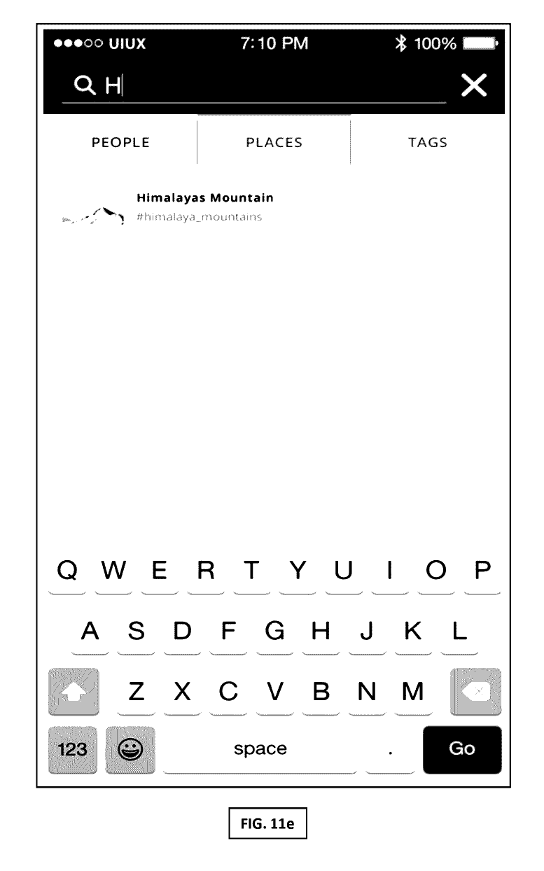

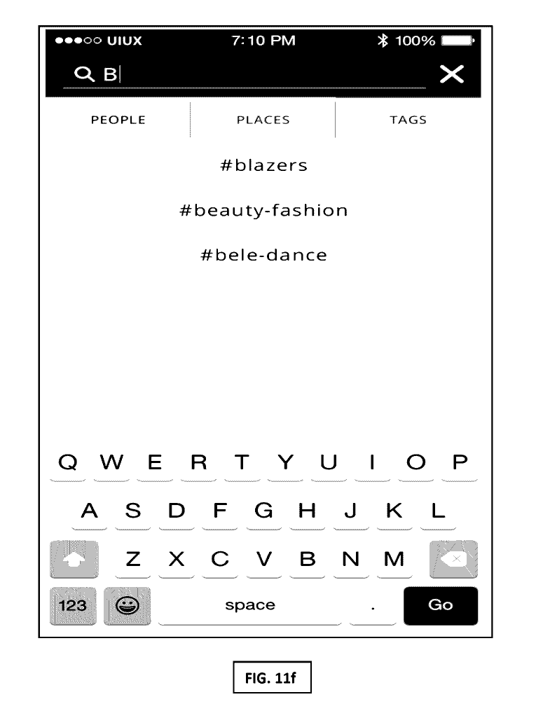

Referring to FIGS. 11a, 11b, 11c, 11d, 11e, and 11f, depict a pictographical representation of ephemeral posting related activity to navigate through the map to view the ephemeral post related activity through the online social media platform 104 and to select active postings captured around the world that are identified with the hash tag names. In an embodiment, the online social media platform 104 depicts the ephemeral postings on the world map pictographically based on the frequency of capturing and uploading the ephemeral postings.

For example, the online social media platform 104 depicts the ephemeral postings with a green larger circle 1101 in certain locations identified with a high ephemeral post uploading and sharing activity within an hour; a blue circle 1102 can depict the locations where image or video uploads are active and are currently uploaded through the online social media platform 104, and depicts the locations where the postings occur between 1-15 hours; and the orange smaller circle 1103 can depict the locations where no current activity is occurring, however the activity had occurred in the past (between 15 hours and 24 hours) through the online social media platform 104. As depicted in FIG. 11b, the active posting captured around the world are listed with the hash tag names, wherein the hash tag name can represent the location, a domain name, a topic, or an area of interest. The user can select the listed hash tag name to view the public story/private story posted in association with the hash tag name. As depicted in FIG. 11c, the navigation map allows the current user 102 to select the areas of interest to view the public story/private story posted at the specified area of interest or location. The location for viewing the public story/private story in the navigation map can be selected by applying filters for searching a city, a state, a distance, or by the number of uploads. As depicted in FIGS. 11d, 11e, and 11f, the current user 102 can view the ephemeral posting by applying search filters for tag names associated with people, place, or generic names.

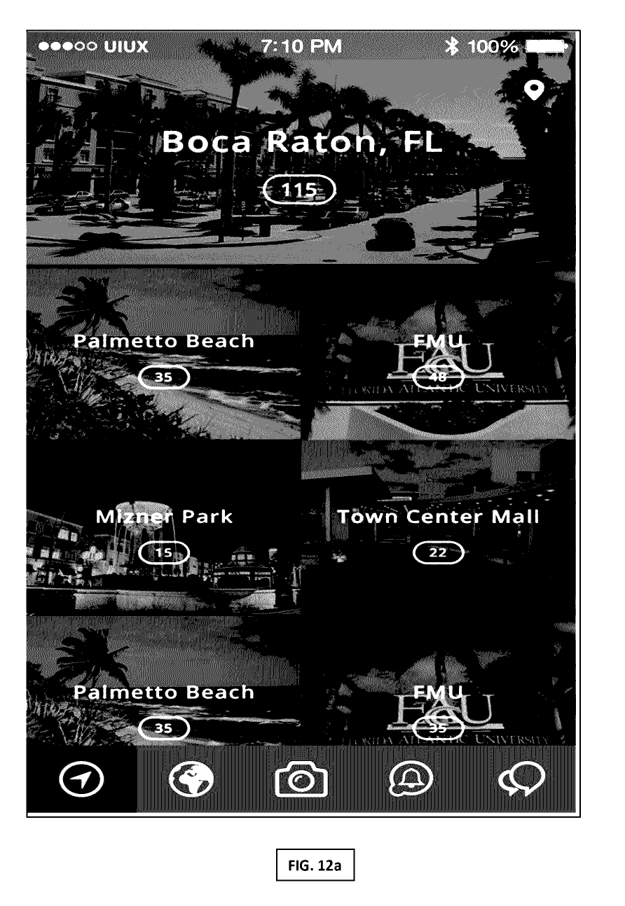

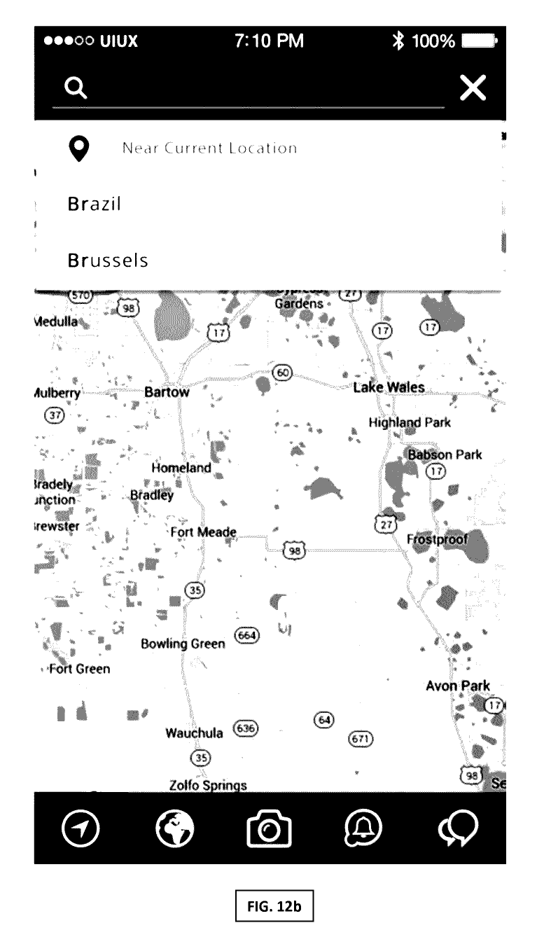

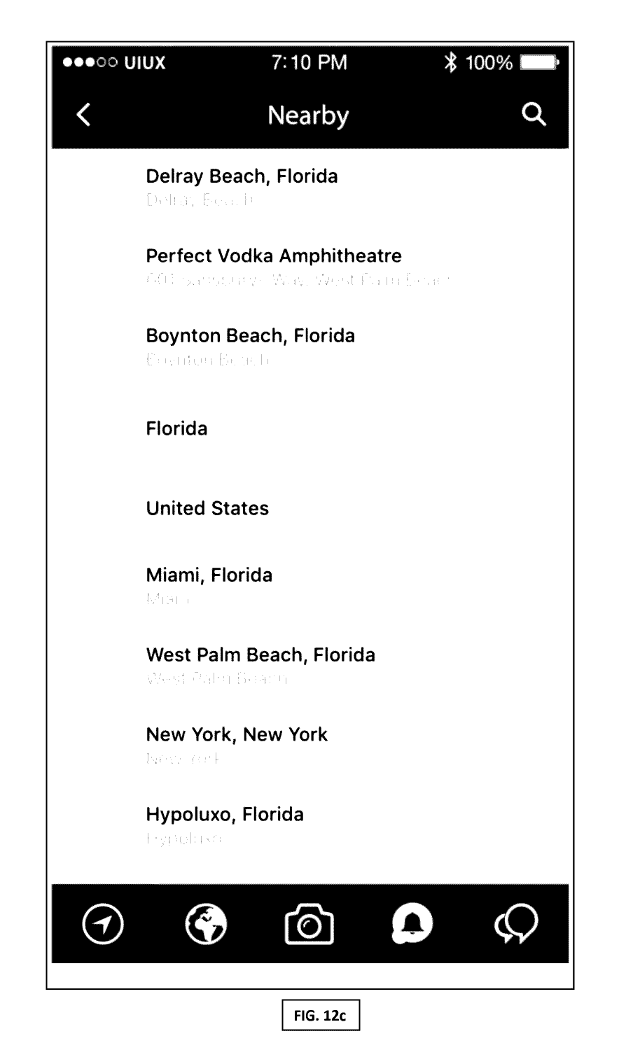

Referring to FIGS. 12a, 12b, and 12c, depicts a Nearby page that displays the most liked uploads at the nearby locations and the most recent uploads recognized within the nearby locations as determined by the online social media platform 104 based on the user's location while capturing/uploading the ephemeral post through the online social media platform 104. For example, as depicted in FIG. 12a, the online social media platform 104 determines the number of most liked ephemeral postings occurring within the vicinity of the user (in Florida) capturing/uploading the ephemeral post through the online social media platform 104 at the top of the page. Further, the most recent uploads of the ephemeral postings captured around the vicinity of the user (in different areas around Florida) are displayed below the most liked ephemeral postings. In another embodiment, as depicted in FIG. 12b, the online social media platform 104 is configured to find the locations by city, state, country on a geographical map that are determined within the vicinity of the user's location. In another embodiment, as depicted in FIG. 12c, the online social media platform 104 allows the user 102 to view the list of places captured around the vicinity of the user's location. By default, the online social media platform 104 lists the places around the vicinity of the user's location by implementing the Geographical Positioning System (GPS).

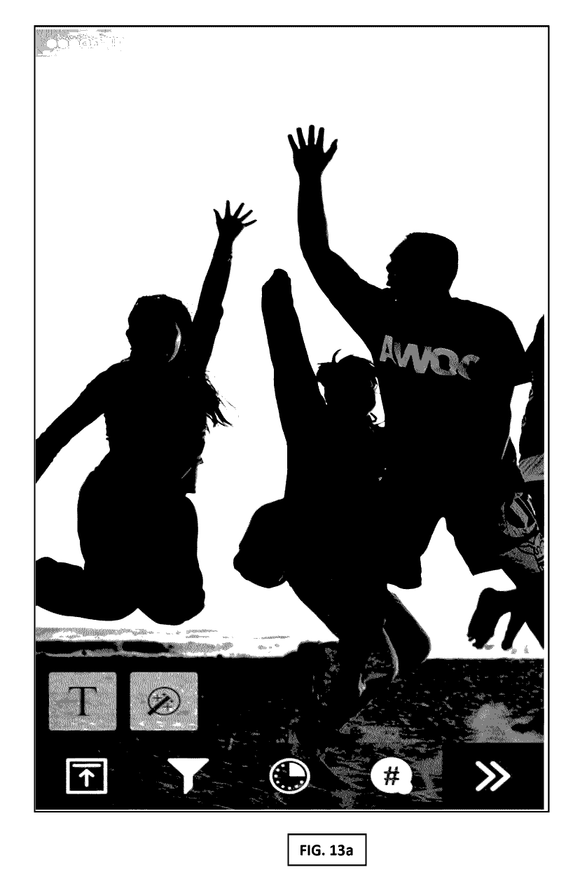

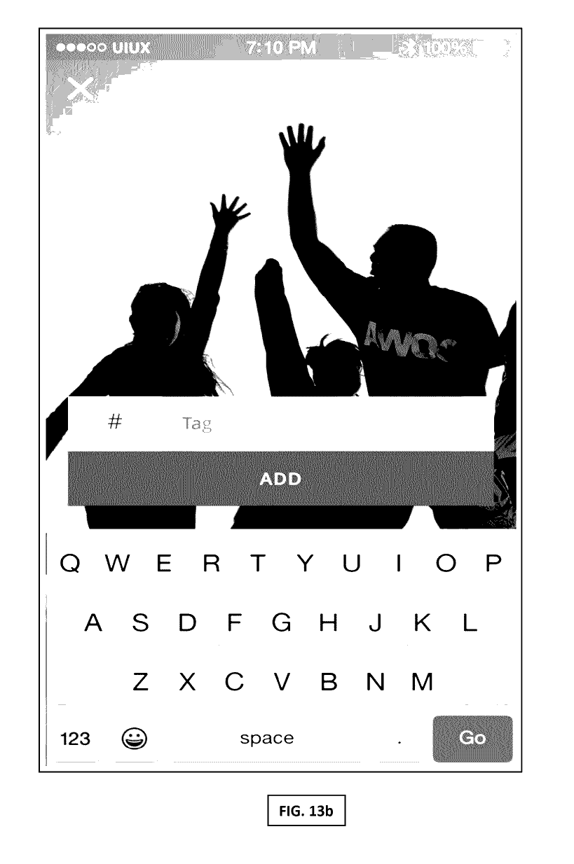

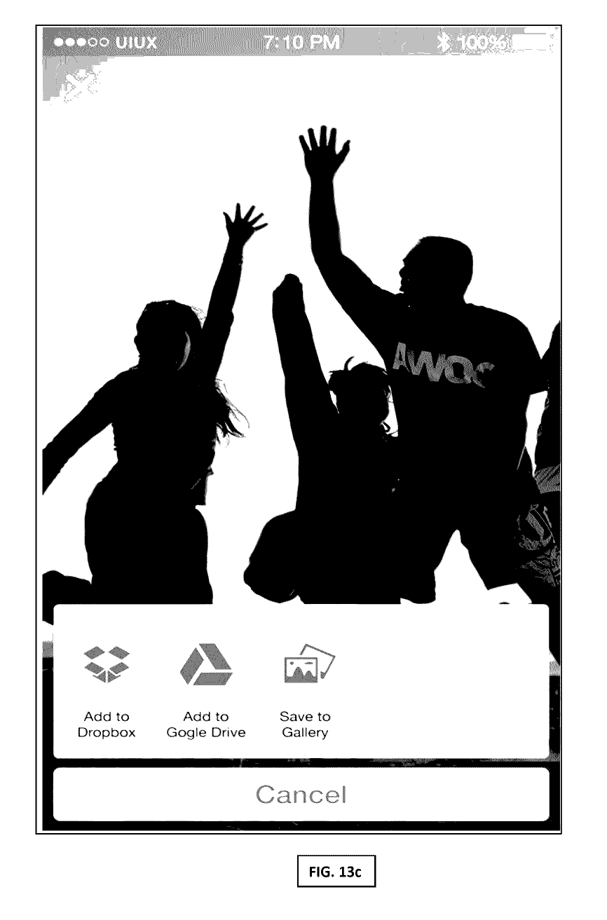

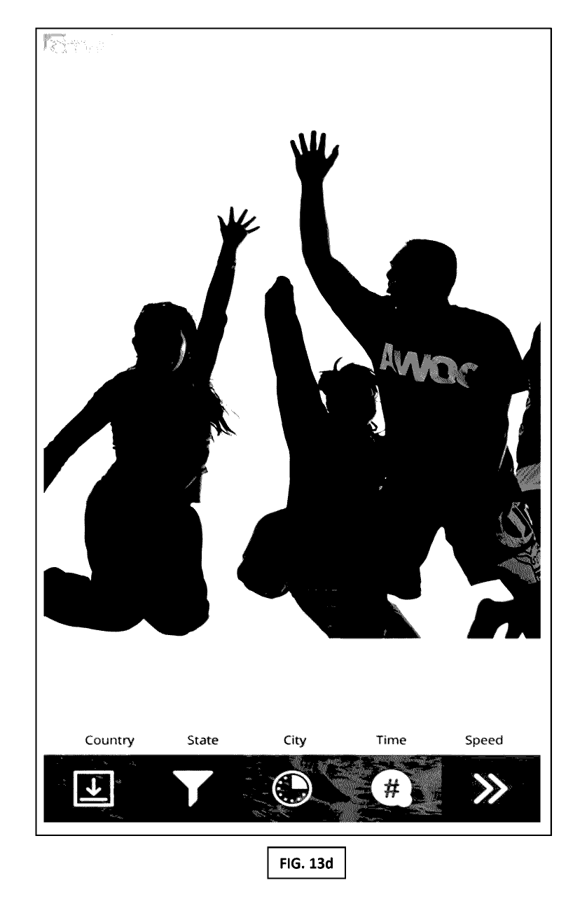

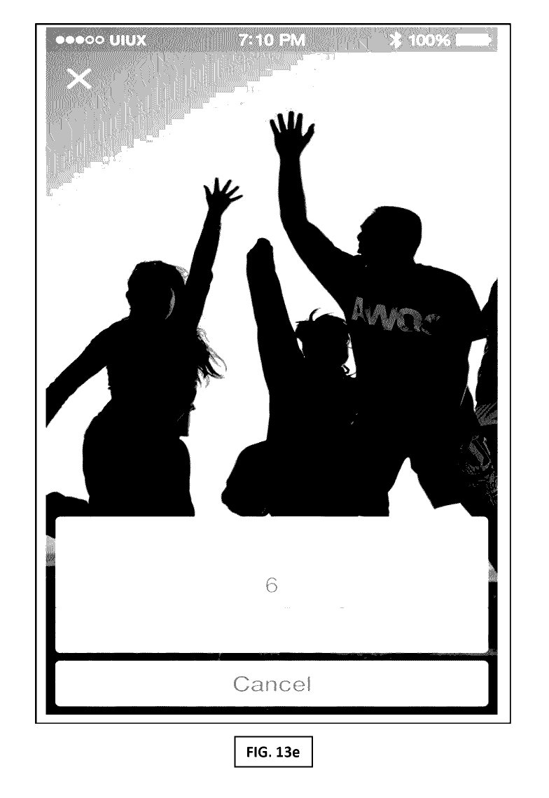

Referring to FIGS. 13a, 13b, 13c, 13d, and 13e, depict screen-shots used to edit the ephemeral post through the mobile interface. In an embodiment, the mobile interface of the online social media platform 104 allows the owner of the ephemeral post to edit the posting before uploading or sharing the ephemeral post with the social networking system entities 105, wherein the mobile interface facilitates the following edits to the ephemeral posting: adding tag names to the ephemeral post, drawing on the ephemeral post, adding time frames for the presentation of the ephemeral picture slide show, sharing the ephemeral post by storing the ephemeral post on storage devices/posting gallery, which can be accessed through various means such as a google drive™, removing the ephemeral post from the stored location, adding search filters to access the ephemeral posts by country name, state name, a city name, time, and speed, adding tag time for picture, saving picture or video, or the like.

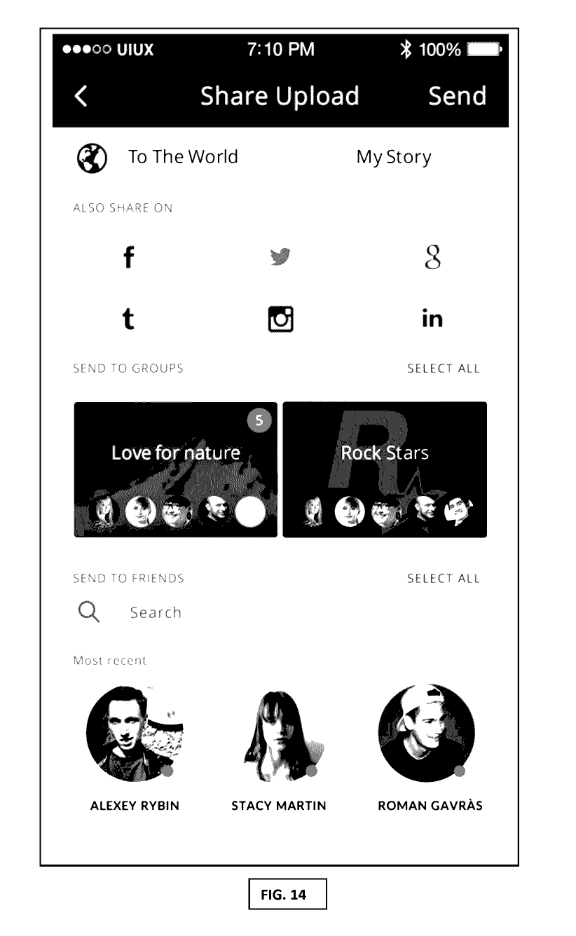

Referring to FIG. 14, depicts a screen-shot used to instantly upload and share the ephemeral post with one or more social networking system entities 105 within the network 101. In an embodiment, the mobile interface displays “The World” tab for sharing the ephemeral post, along with the user's profile, instantly with the public and the “My Story” tab for sharing the user's profile (along with the ephemeral post) instantly with the following user(s).

In an embodiment, when the ephemeral post is uploaded through the World tab the ephemeral posting will be available in the Nearby page (FIG. 12a) and the World page (FIG. 11a), wherein the online social media platform 104 automatically places the uploaded ephemeral post based on the current user's location. Further, through the online social media platform 104, the current user following other user's profile receives the user shared ephemeral post (public and private) in the notification page that is shared for the public. In an embodiment, the public story of a private user's profile can be viewed by the public.

In an embodiment, when the ephemeral post is uploaded through My Story tab of the mobile interface, the ephemeral posting can only be viewed by other user(s) who are following the current user's profile. Further, other user(s) can access the ephemeral postings uploaded/shared through the third party social media web sites if the user(s) are connected to the third party social media web sites. Further, the ephemeral postings uploaded/shared through the third party social networking sites can be managed by the associated third party social media web sites.

In an embodiment, the ephemeral posting shared through the initiated group/single chat sessions can be viewed once by the group chat users/individual chat users and will be automatically deleted from the instance of the chat sessions as the group chat users/individual chat users view the ephemeral post.

In an embodiment, the ephemeral posting shared through the individual chat sessions can be viewed once by the individual chatting user(s) and will be automatically deleted from the instance of the chat sessions as the individual chatting user(s) views the ephemeral post.

In an embodiment, the current user has the option to select one or more of the above options to share the ephemeral postings through the online social media platform 104. Further, when the user uploads to the World tab or to the My story tab the receiving followers will receive the notification from both the World tab and the My story tab. However, the user(s) connected through the third-party social media web site, initiated group chatting sessions, initiated individual chatting sessions will not receive the uploaded/shared ephemeral postings. The social networking system entity (ies) 105 with the privilege to access the user's profile, along with the ephemeral post, is allowed to view the profile. Further, the ephemeral post shared through “The World” tab or the “My Story” tab can retain the ephemeral post for a limited period of time like 24 hours, and the ephemeral post uploaded at this location gets deleted as the ephemeral post is viewed by the social networking system entity (ies) 105.

In another embodiment, the online social media platform 104 allows the user 102 to share the ephemeral post instantly with one or more integrated third-party social media web site followers.

In another embodiment, the online social media platform 104 allows the user 102 to share the ephemeral post instantly with a group configured by the user 102 or with the public. Further, as the ephemeral post is viewed by the group/individuals the ephemeral post will be removed from the online social media platform 104, and the ephemeral post shared through the group can be retained in the online social media platform 104 until the group members or the individuals of the group view the ephemeral post.

In another embodiment, the online social media platform 104 allows the user 102 to share the ephemeral post instantly with the following list of users and the ephemeral post can be viewed by the following list of users.

In an embodiment, the search field allows the user(s) to search for people to connect with and view their ephemeral post instantly through the online social media platform 104. Further, as the current user searches for the required list of users and connects with the selected list of users, the connected list of users can receive the ephemeral posts through the online social media platform 104.

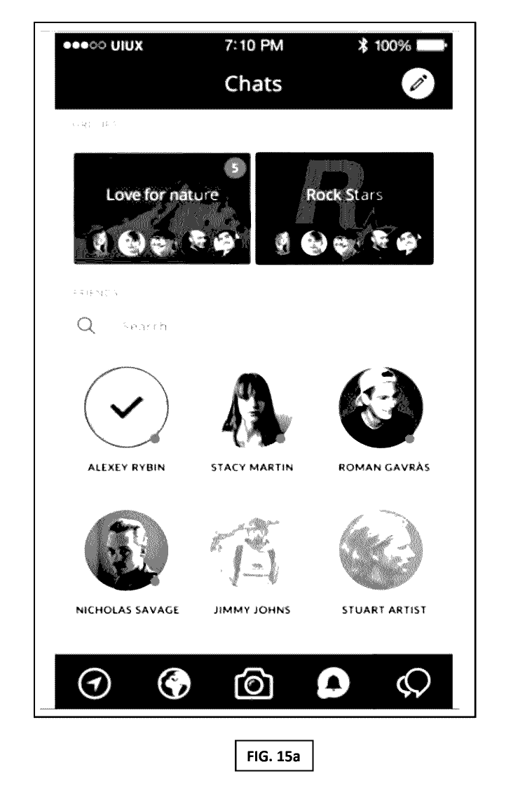

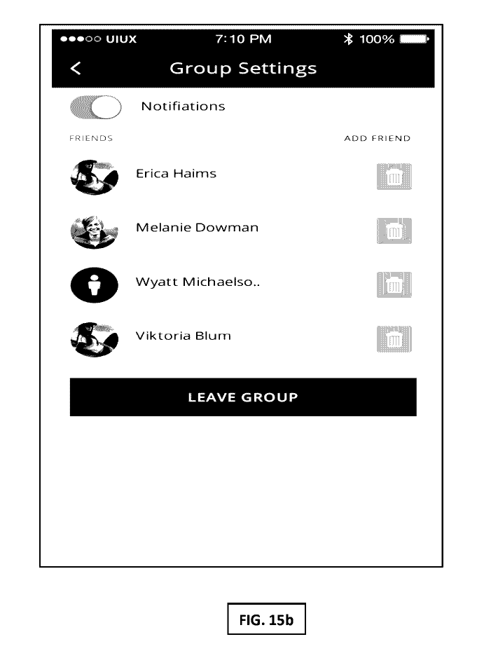

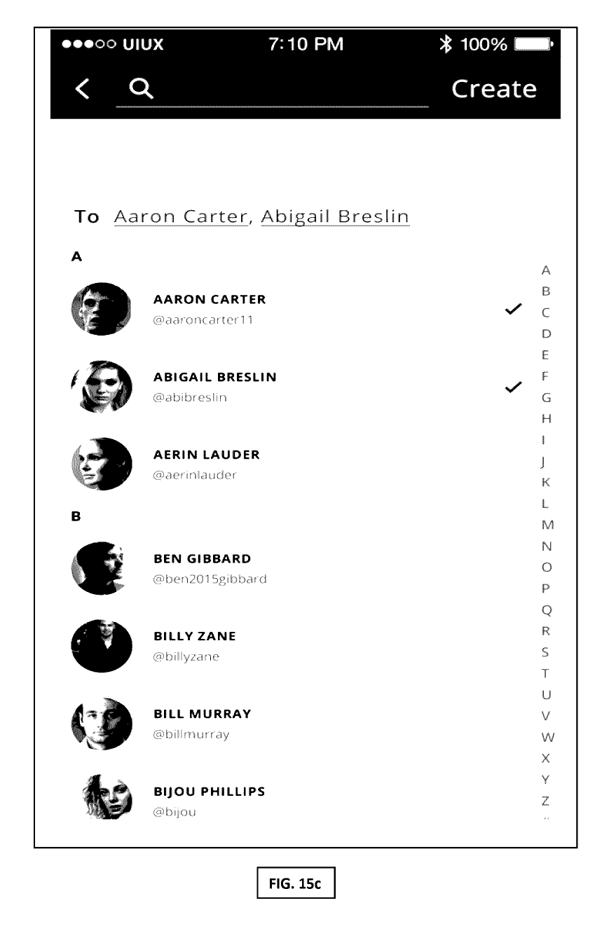

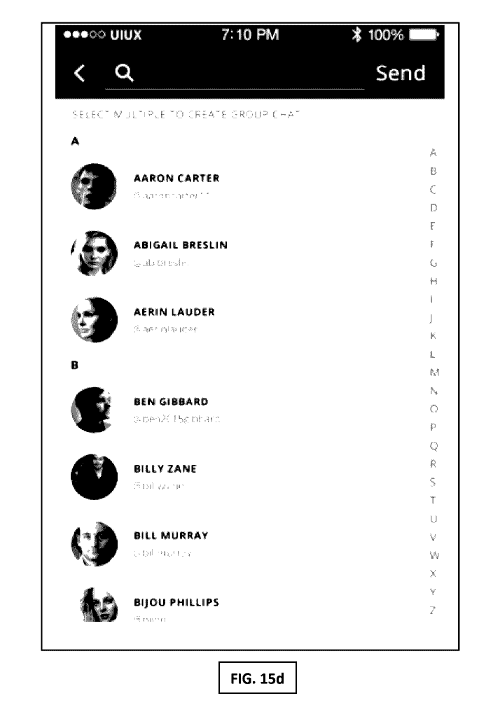

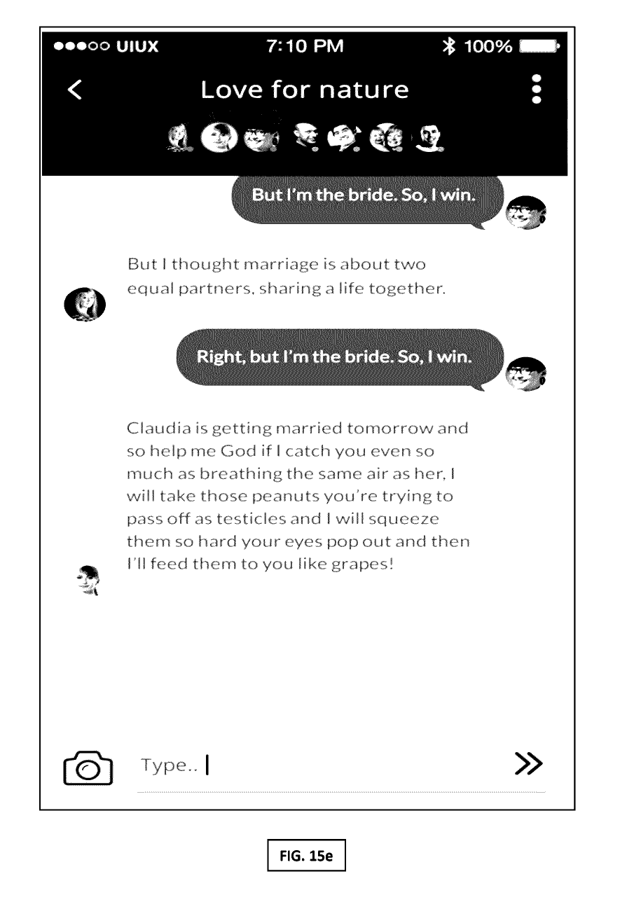

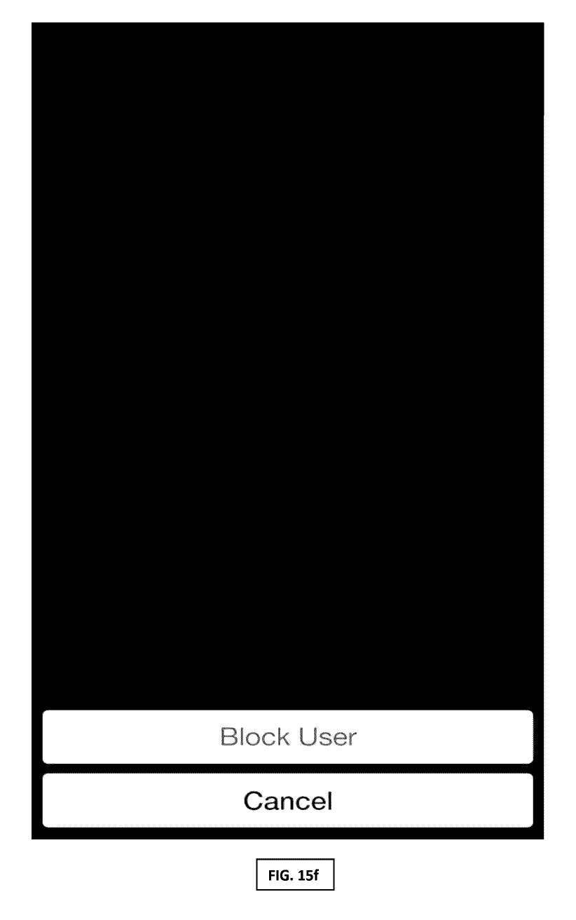

Referring to FIGS. 15a, 15b, 15c, 15d, 15e, and 15f, depicts screen-shots used to initiate an online ephemeral individual chatting session and/or an ephemeral group chatting session and to view the ephemeral chatting session text, image, video in real-time. In an embodiment, the online social media 104 allows the user to initiate either an individual chatting session by inviting a following list of users or a group chatting session by inviting a following group of users through a chat room, as depicted in FIG. 15a. In an embodiment, as depicted in FIG. 15b, the online social media platform 104 allows the user to configure a group chatting session through the Group Settings page. In an embodiment, the mobile interface (through the Group Settings page) allows the following user(s), part of the initiated group chatting session, to leave the chat room session from the initiated group chatting session. FIGS. 15c and 15d, allows the current user to create a group chatting session and to invite the following list of users to the initiated group chatting session. FIG. 15e, illustrates an exemplary screen-shot of multiple users communicating through the initiated group chatting session. In an embodiment, the method 103 allows each of the group chatting session member to view the ephemeral posts (chat text, image(s), video(s)) shared through the session. FIG. 15f, depicts an individual group chatting session communication occurring within the initiated individual group chatting session.

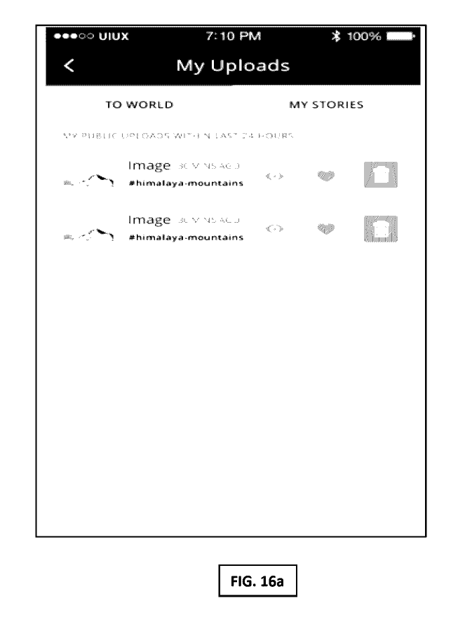

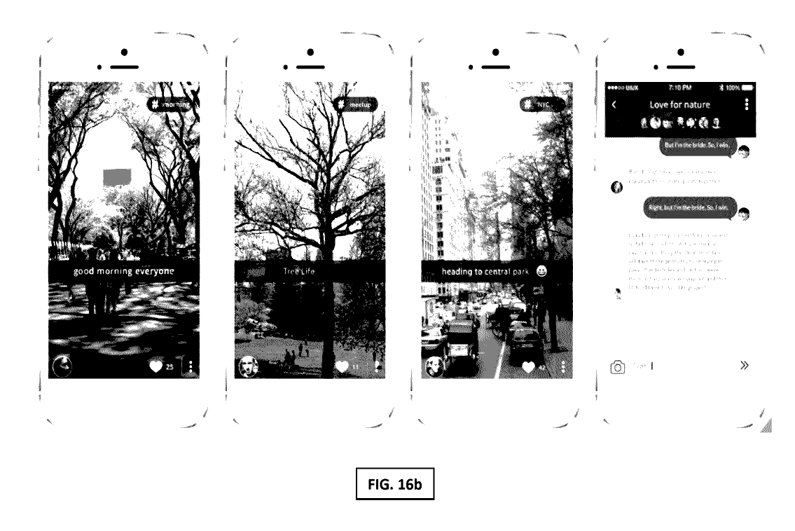

Referring to FIGS. 16a and 16b, depicts screen-shot used to upload the ephemeral post through the online social media platform 104 and to view the ephemeral postings shared through the group chatting session initiated through the online social media platform 104. As depicted in FIG. 16a, the My Uploads page of the mobile interface allows the user to upload the ephemeral post to the “To World” tab or to the “My Stories” tab. The “To World” tab allows the current user to share the ephemeral post (a public story) with the public and the “My Stories” tab allows the current user to share the private story with the private list of users or with the list of users following the registered user. Further, the page allows the current user to view the number of public stories uploaded by the current user within 24 hours, the number of likes received for the uploaded postings, the number of views associated with the uploaded postings, and allows the current user to delete the uploaded postings from online social media platform 104. FIG. 16b, depicts an initiated group chatting session initiated through the online social media platform 104. In an embodiment, as the uploads are shared through the group chatting session, the method 103 allows each of the chatting session members to view the uploads before proceeding with the chat room session to exchange the text messages. Further, as the chat room session members enter the chat room session, an instance of the upload created for each of the participating members are deleted. Further, the text exchanged through the chat session room can be viewed by the participating members and the instance of the text will be deleted as the participating members leave the chat room session.

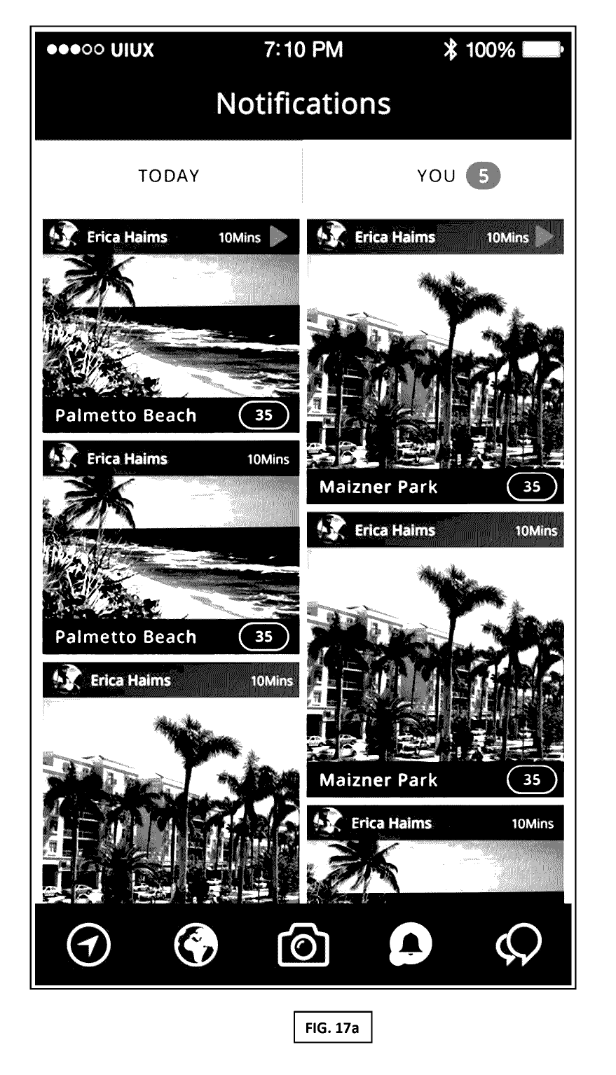

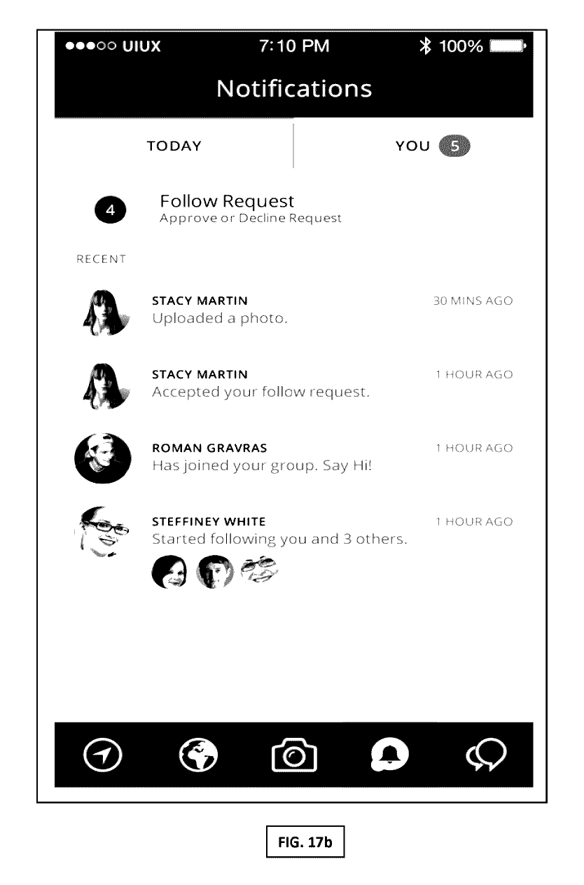

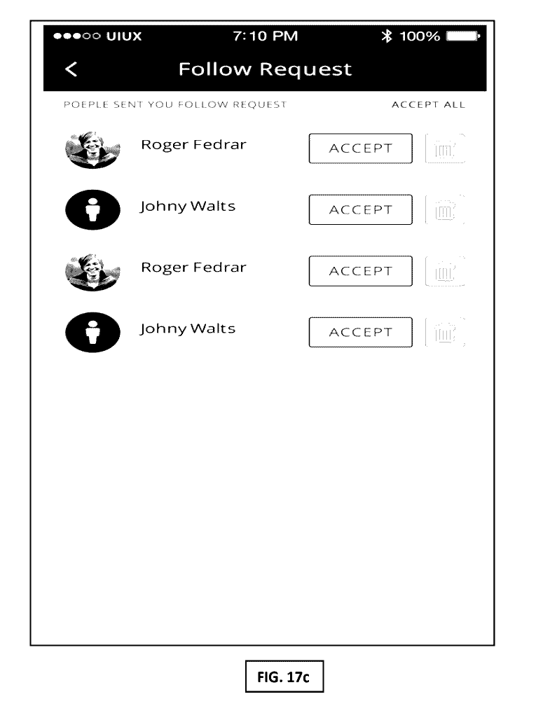

Referring to FIGS. 17a, 17b, and 17c, depict screen-shots used to view the notification information received from the following user(s) and the ephemeral post related activity performed by the current user through the online social media platform 104. In an embodiment, the mobile interface is configured with a notification screen to display two tabs. As per the screen-shot, the Today tab displays the private story content and the public story content uploaded by the following users through the online social media platform 104 within 24 hours. In another embodiment, the “You” tab displays all the notifications related to the current user specific related activity (ies) performed through the online social media platform 104 and recent interactions of the following user(s) with the current user captured through the online social media platform 104. In an embodiment, the current user specific related activity (ies) comprises of listing the current user's followers, uploads, chat conversations, likes, or the like. As depicted in FIG. 17c, the mobile interface allows the current user to either accept or deny the follow request sent by the private list of users within the network 101.

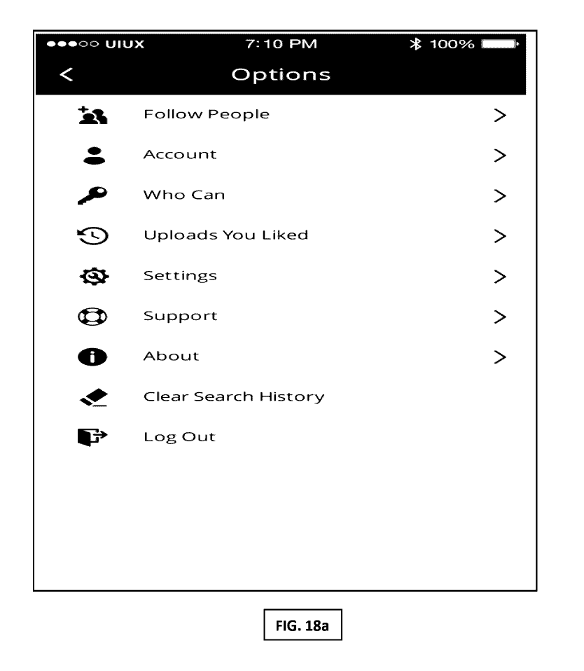

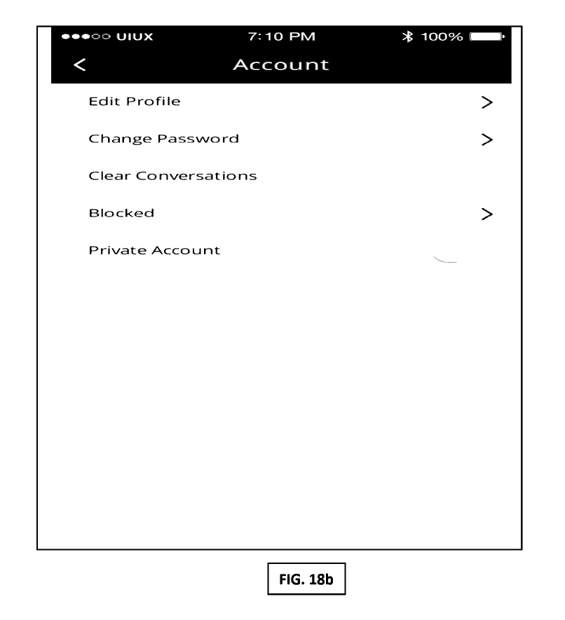

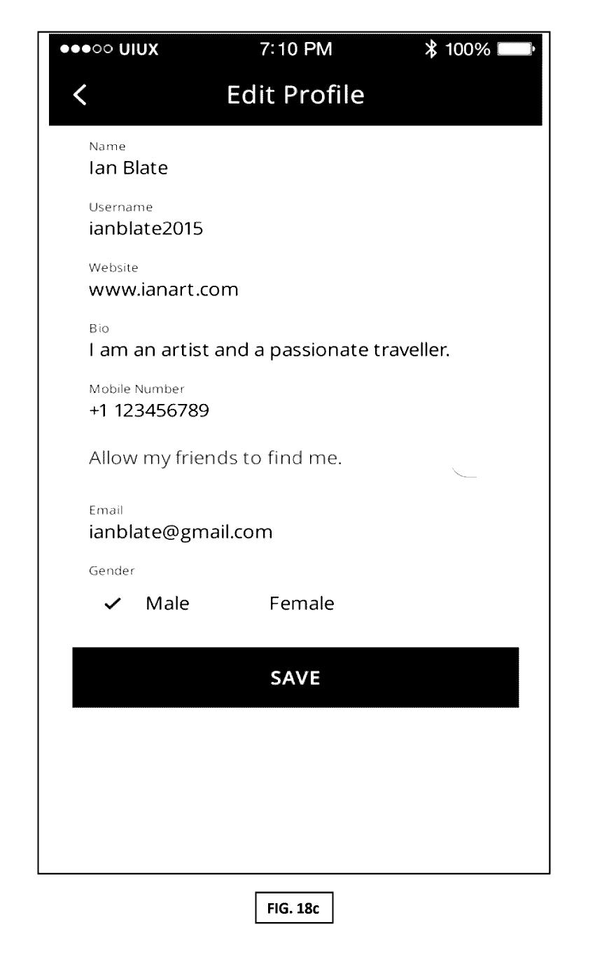

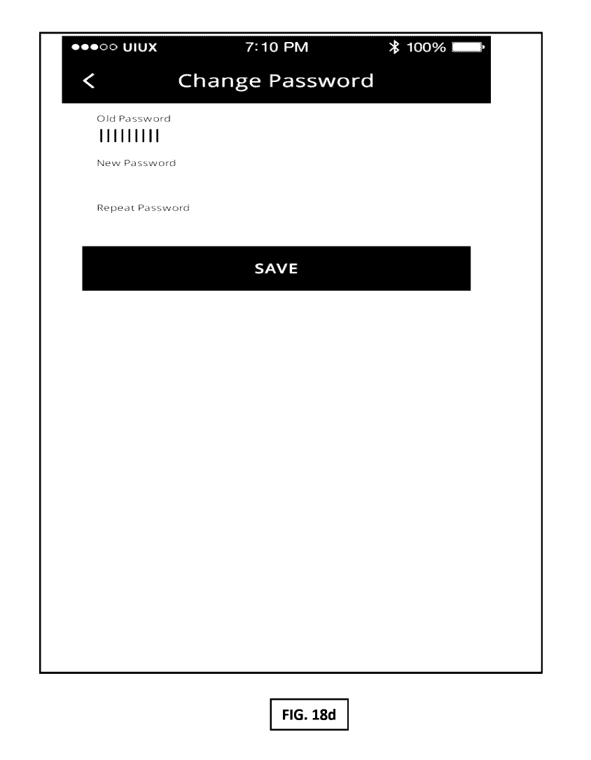

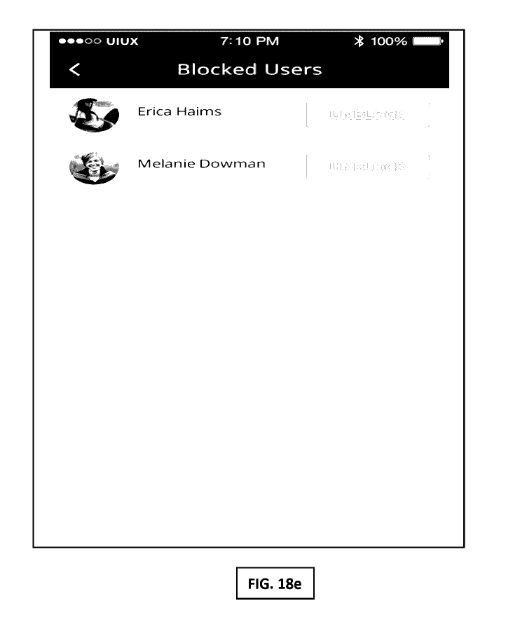

Referring to FIGS. 18a, 18b, 18c, 18d, and 18e depict screen-shots used to configure the privilege settings for uploading and sharing the ephemeral post through the online social media platform 104. In an embodiment, the mobile interface is configured with the “Options” page for allowing the user to configure the user's account, configure the privilege to access the user's profile and the ephemeral post, track the ephemeral posting likes selected by the user, edit the existing configuration setting, or the like. As depicted in FIG. 18b, the “Account” page of the mobile interface allows the user to edit the user profile, password, and block/unblock the user(s) from following the user's profile. As depicted in FIG. 18c, the “Edit Profile” page of the mobile interface allows the user to edit the user's profile, such as the user name, a website address, a phone number, an email address, and other personal details of the user's profile. If the privilege setting for the current user is private then other users will be able to view only public uploads and the user's profile can be viewed by other user(s) only after the current user accepts the request or other user(s) is allowed to follow the user's profile. However, if the privilege setting for the current user is set as public then other user(s) will be able to view both the public (the world) and the private (my story) part of the user's profile.

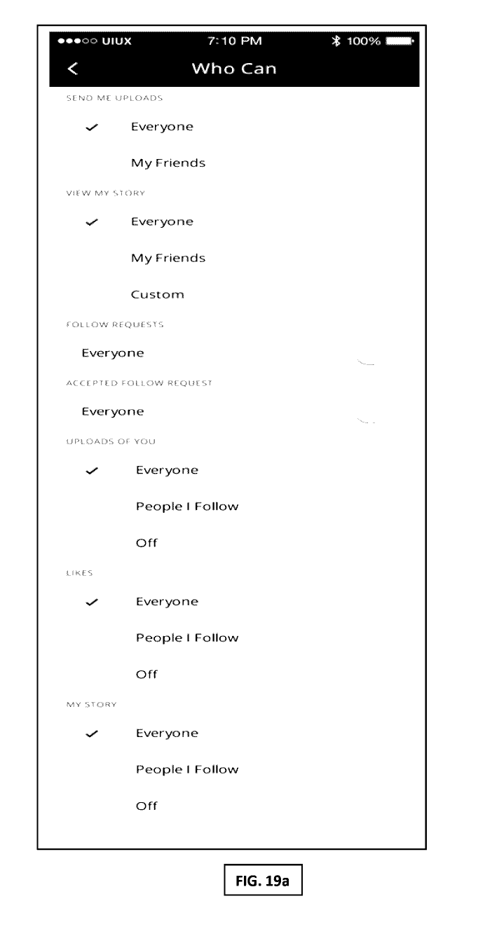

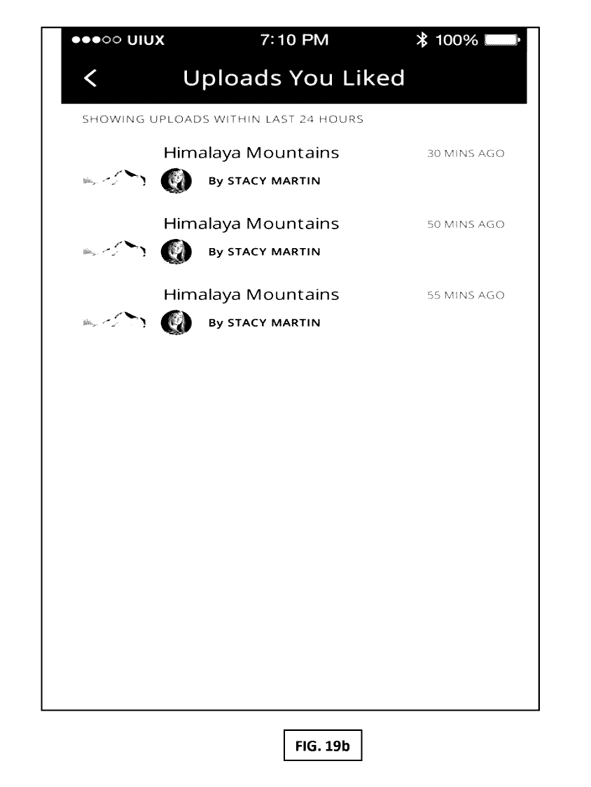

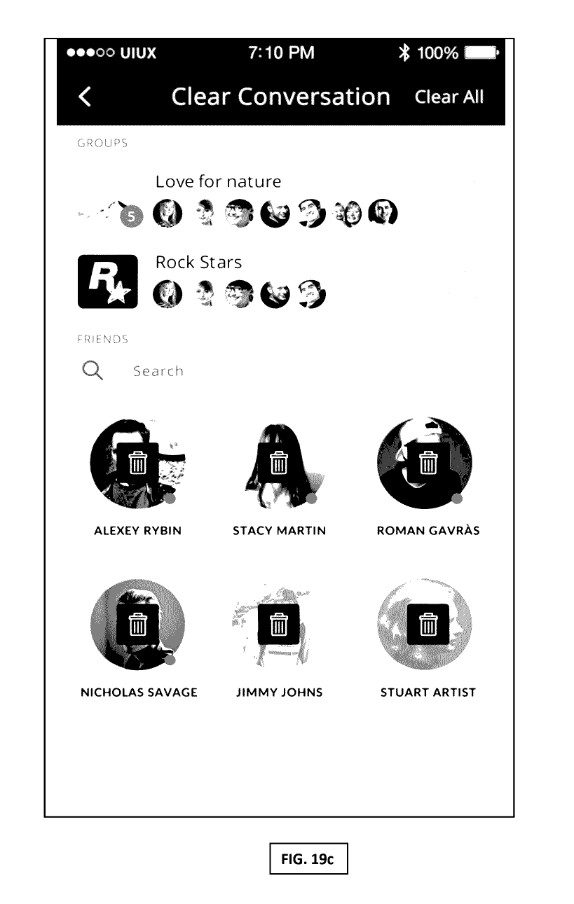

Referring to FIGS. 19a, 19b, 19c, depict screen-shots used to configure the privacy settings for the ephemeral post, uploads liked by the registered user, and clearing conversation in the chat room through the online social media platform 104. In an embodiment, the mobile interface is configured with the privacy settings for selecting the user(s) profile to be followed in real-time through the online social media platform 104. As depicted in FIG. 19a, the privacy settings allow the current user to configure the permissions for accessing the ephemeral postings. As depicted in FIG. 19b, the mobile interface is configured to display the number of uploads the user has completed within the specified period of time (24 hours), and FIG. 19c, depicts the mobile interface to clear/delete the conversation tracked in an initiated ephemeral chat room (group chatting session, individual chatting session), exchanged with other users through the online social media platform 104, after the user(s) views the ephemeral post through the initiated ephemeral chat room or leaves the initiated ephemeral chat room. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims. Although the embodiments herein are described with various specific embodiments, it will be obvious for a person skilled in the art to practice the invention with modifications. However, all such modifications are deemed to be within the scope of the claims.

What is claimed is:

1. A method implemented for extracting the location of a registered user while performing an ephemeral post related activity in real-time through an online social media platform based on the privilege setting configured by said registered user within a network, wherein said method comprises of:
identifying a plurality of locations around the vicinity of said registered user's location when an ephemeral posting is captured and shared in real-time within the network by said registered user;
allowing said registered user to capture the ephemeral post in at least one mode through said online social media platform;
initiating an ephemeral chat session through said online social media platform;
allowing said registered user to edit the ephemeral post through said online social media platform;
depicting said plurality of locations as a public story based on the frequency of capturing and posting said ephemeral posting in real-time through said social media platform;
categorizing the ephemeral posting based on at least one factor including the extracted location of said registered user while performing said ephemeral post related activity in real-time through said social media platform; and
receiving notification information about said ephemeral post related activity performed by at least one other user through said social media platform.

2. The method as claimed in claim 1, wherein said ephemeral post related activity comprises of sharing, uploading, editing an image posting, a video posting, a registered user's profile through said online social media platform in real-time.

3. The method as claimed in claim 1, wherein the online social media platform comprises of an online networking community such as: a social networking site, a public network, a private network including a following list of users, a groups list, a followers list, a group chat list, or the like with whom the ephemeral posting can be shared.

4. The method as claimed in claim 1, wherein the notification information captured by said online social media platform comprises of receiving the updated stories/activities performed by said at least one other user followed by the registered user's profile or tracking the activities performed by said registered user through said online social media platform.

5. The method as claimed in claim 4, wherein the activities tracked by said registered user through said online social media platform comprises of: notifying the updated list of followers for the registered user's profile, number of uploads handled by said registered user through said online social media platform, the chat conversation related information handled by said registered user, number of likes selected by said registered user, number of views tracked for the registered user, or the like.

6. The method as claimed in claim 1, wherein editing the ephemeral post comprises of adding tags to the ephemeral post, adding time-stamps for viewing the ephemeral post, storing the ephemeral post at a location based on the registered user's location, deleting or removing the ephemeral post from the stored location, configuring the privilege settings for sharing the ephemeral post through said online social media platform within the network.

7. The method as claimed in claim 1, wherein the method allows the registered user to configure the privilege setting to share the ephemeral post with the public or with a private list of contacts within the network.

8. The method as claimed in claim 1, wherein the method allows the registered user to capture said ephemeral post in at least one mode that comprises one of: a frontback mode, a video capturing mode, a photo capturing mode, a time lapse mode, or a slow motion mode.

9. The method as claimed in claim 1, wherein said public story refers to the accumulation of a plurality of said ephemeral posts that are posted by a plurality of users based on the registered user's location.

10. The method as claimed in claim 1, wherein the method receives the notification information about said ephemeral post related activity either through said public story or a private story.

11. The method as claimed in claim 10, wherein said private story refers to the accumulation of a plurality of said ephemeral posts that are posted by the registered user and shared with a private list of users following the registered user.

12. The method as claimed in claim 8, wherein the method removes the captured said ephemeral post from said online social media platform as said at least one other user view said ephemeral post through said initiated ephemeral chat session.

13. The method as claimed in claim 12, wherein the initiated ephemeral chat session comprises of either a group ephemeral chat session involving a plurality of users participating in an initiated chat session or an individual ephemeral chat session involving a pair of users participating in said initiated chat session.

14. The method as claimed in claim 13, wherein the initiated ephemeral chat session allows said plurality of users participating in said chat session or said pair of users participating in said individual ephemeral chat session to initially view the uploads and then proceed to communicate through said initiated ephemeral chat session.

15. The method as claimed in claim 14, wherein the method deletes the initially viewed uploads as the plurality of users or said pair of users proceeds to communicate through said ephemeral chat session.

16. The method as claimed in claim 1, wherein said at least one factor that can categorize the ephemeral post comprises of: uploading ephemeral posts at a specific location ephemeral posts uploaded with a specific tag name, ephemeral posts uploaded for a particular event/occasion, or the like.

17. A computer program product comprising computer executable program code recorded on a computer readable non-transitory storage medium, said computer executable program code when executed, causing the actions including:
extracting the location of a registered user while performing an ephemeral post related activity in real-time through an online social media platform based on the privilege setting configured by said registered user within a network,
identifying a plurality of locations around the vicinity of said registered user's location when an ephemeral posting is captured and shared in real-time by said registered user through an online social media based on the privilege setting configured by said registered user within a network;
capturing the ephemeral post in at least one mode through said online social media;
allowing said registered user to initiate an ephemeral chat session through said online social media
allowing said registered user to edit the ephemeral post before sharing the ephemeral post through said online social media.
depicting said plurality of locations as a public story based on the frequency of capturing and posting said ephemeral posting in real-time through said social media platform; and
categorizing the ephemeral posting based on at least one factor including the extracted location of said registered user while performing said ephemeral post related activity in real-time through said social media platform.

18. The computer program product as claimed in claim 17, wherein said ephemeral post related activity comprises of sharing, uploading, editing an image posting, a video posting, a registered user's profile through said online social media in real-time within the network.

19. The computer program product as claimed in claim 17, wherein the product is configured to remove the captured said ephemeral post from said online social media platform as said at least one other user view said ephemeral post through said initiated ephemeral chat session.

20. The computer program product as claimed in claim 17, wherein the online social media comprises of an online networking community such as: a social networking site, a public network, a private network that includes a following list of users, a groups list, a followers list, a following list, a group chat list, or the like with whom the ephemeral posting can be shared.

21. The computer program product as claimed in claim 17, wherein editing the ephemeral post comprises of adding tags to the ephemeral post, adding time-stamps for viewing the ephemeral post, storing the ephemeral post at a location based on the registered user's location, deleting or removing the ephemeral post from the stored location, configuring the privilege settings for sharing the ephemeral post through said online social media within the network.

22. The computer program product as claimed in claim 17, wherein the notification information captured by said online social media platform comprises of receiving the updated stories/activities performed by said at least one other user followed by the registered user's profile or tracking the activities performed by said registered user through said online social media platform.

23. The computer program product as claimed in claim 22, wherein the activities tracked by said online social media platform comprises of: notifying the updated list of followers for the registered user's profile, number of uploads handled by said registered user through said online social media platform, the chat conversation related information handled by said registered user, number of likes selected by said registered user, number of views tracked for the registered user, or the like.

24. The computer program product as claimed in claim 17, wherein the product allows the registered user to configure the privilege setting to share the ephemeral post with the public or with a private list of contacts within the network.

25. The computer program product as claimed in claim 17, wherein the product is configured to capture said ephemeral post in at least one mode that comprises one of: a frontback mode, a video capturing mode, a photo capturing mode, a time lapse mode, or a slow motion mode.

26. The computer program product as claimed in claim 17, wherein said public story refers to the accumulation of a plurality of said ephemeral posts that are posted by a plurality of users based on the registered user's location.

27. The computer program product as claimed in claim 17, wherein the product is configured to receive the notification information about said ephemeral post related activity either through said public story or a private story.

28. The method as claimed in claim 27, wherein said private story refers to the accumulation of a plurality of said ephemeral posts that are posted by the registered user and shared with a private list of users following the registered user.

29. The computer program product as claimed in claim 19, wherein the initiated ephemeral chat session comprises of either a group ephemeral chat session involving a plurality of users participating in an initiated chat session or an individual ephemeral chat session involving a pair of users participating in said initiated chat session.

30. The computer program product as claimed in claim 29, wherein the initiated ephemeral chat session allows said plurality of users participating in said chat session or said pair of users participating in said individual ephemeral chat session to initially view the uploads and then proceed to communicate through said initiated ephemeral chat session.

31. The computer program product as claimed in claim 30, wherein the method deletes the initially viewed uploads as the plurality of users or said pair of users proceeds to communicate through said ephemeral chat session.

32. The computer program product as claimed in claim 17, wherein said at least one factor associated with the ephemeral posting posted in real-time through said social media platform can categorize the ephemeral post based on: the ephemeral posts uploaded at a specific location, the ephemeral posts uploaded with a specific tag name, ephemeral posts uploaded for a particular event/occasion, or the like.
